(19) United States
(12) Patent Application Publication
(10) Pub. No.: US 2007/0236835 A1
(43) Pub. Date: Oct. 11, 2007

(54) Magnetic recording medium

(75) Inventors: Masahito Oyanagi, Odawara-shi (JP); Nobuyuki Kawano, Kanagawa (JP); Shiho Kamisawa, Kanagawa (JP); Kazuko Hanai, Kanagawa (JP)

Correspondence Address: SUGHRUE-265550, 2100 PENNSYLVANIA AVE. NW, WASHINGTON, DC, 20037-3213, US

(73) Assignee: FUJIFILM Corporation, Tokyo (JP)

(21) Appl. No.: 11/730,394

(22) Filed: Apr. 2, 2007

(30) Foreign Application Priority Data
Mar. 31, 2006 (JP) 2006-099938

(51) Int. Cl. G11B 5/74

(52) U.S. Cl. 360/131

(57) ABSTRACT

A magnetic recording medium includes a nonmagnetic support; and a magnetic layer that comprises a binder and ferromagnetic powder dispersed in the binder, wherein δ is 10 to 100 nm; and σ_{d} is from 5 to 50 nm in terms of coating layer in the magnetic recording medium, wherein δ represents an average thickness of the magnetic layer; and σ_{d} represents a standard deviation that is obtained by measuring by TOF-SIMS a depth profile of an element present only in the magnetic layer among elements constituting the ferromagnetic powder and subjecting a differential curve of the depth profile to a normal distribution curve fitting.

### BACKGROUND OF THE INVENTION

1. Field of the Invention

The present invention relates to a magnetic recording medium that can deliver excellent electromagnetic conversion characteristics at the time of high-density recording.

2. Description of the Related Art

Magnetic recording technology possesses excellent features missing in other recording systems, including (a) capability of using a medium repeatedly, (b) easiness of digitizing signals and possibility of system construction by combination with peripheral devices and (c) simplicity of signal correction, so it has been widely utilized in various areas, notably those of applications to videos and computers.

For the purpose of meeting market requirements, such as downsizing of equipment, improvements in quality of recorded and played-back signals, extension of recording time and increase in recording capacity, it has been desired at all times to ever-more enhance the packing density, reliability and durability of recording media.

For instance, in response to commercialization of digital recording systems which realize improvements in sound and image qualities and development of recording systems supporting for Hi-Vision TVs, there is a growing demand for magnetic recording media which enable recording and playback of signals with wavelengths much shorter than those in traditional systems and ensure excellent reliability and durability even under increased relative velocity between a head and the media. In the area of application to computers as well, there is a growing desire to develop large-capacity digital recording media for storage of an increasing amount of data. In the area of magnetic disks also, a great increase in capacity of flexible disks is desired under current circumstance where an upsurge in amount of data to be handled is taking place. As large-capacity disks using particulate ferromagnetic metals superior in high-density recording characteristics, though high-density FDs of 100 MB or above are in practical use, demand for still higher-capacity higher-speed transmission systems is developing.

In order to achieve high packing densities of magnetic recording media, it is being strongly pursued to make the wavelengths of recording signals shorter and the track width of a playback head narrower. When the length of an area for recording a signal reaches a magnitude comparable with the particle size of magnetic powder used, it is impossible to create a clear magnetic transition state, so recording becomes impossible in a substantial sense. Therefore, it is necessary to develop magnetic substances having sufficiently small particle sizes as compared with the shortest wavelength used, and reduction in particle sizes of magnetic substances has been aimed for many years.

A magnetic tape used in a system for recording digital signals has on one side of a nonmagnetic support a relatively thick magnetic layer which has a single-layer structure and a thickness of 2.0 to 3.0 μm and contains ferromagnetic powder, a binder and an abrasive, and besides, it has on the other side a backing layer for the purposes of preventing winding irregularities and ensuring satisfactory running durability. However, the relatively thick magnetic layer of a single-layer structure has a self-demagnetization problem in the process of recording, and besides, it has a thickness-loss problem, or output reduction, in the process of playback.

It is known to reduce the thickness of a magnetic layer for the purpose of improving the reduction in playback output due to the magnetic-layer thickness loss, and there is disclosure of the magnetic recording medium having on a nonmagnetic support a lower nonmagnetic layer containing inorganic powder dispersed in a binder and an upper magnetic layer which has a thickness of 1.0 μm or less, contains ferromagnetic powder dispersed in a binder and is formed while the nonmagnetic layer is still in a wet state (See, e.g., JP-A-8-306032).

In recent years, devices for conveying information of the order of terabytes at a high speed have reached significantly high-level of sophistication, and it has become possible to transmit images and data with massive amounts of information, while highly developed technologies for recording, playback and storage of such images and data have come to be required. At present, on the other hand, further increase in recording capacity is required for both recording/playback apparatus and magnetic recording media with a rise in the level of technological sophistication.

As to magnetic tapes, they have various uses, such as audio tape use, video tape use and computer tape use. In the area of tapes for data backup use in particular, tapes having recording capacities of several decades to 800 GB per roll are already on the market in response to upsurges in capacities of hard disks which are subjects of backup.

Moreover, there are suggestions for backup tapes with large capacities in excess of 1 terabyte, and such increases in recording capacity will become indispensable in the future.

As approaches to increasing recording capacity from the viewpoint of manufacturing magnetic tapes, techniques for further heightening recording densities, including those for reducing particle sizes of magnetic powders, filling a coating film with such fine particles in a higher density, smoothing the coating film and reducing the magnetic layer thickness, have been put forth.

On the other hand, playback heads utilizing magnetoresistance (MR) as the principle of operation have been offered in recent years, and a start has already been made at using them. Patent Document 2 cited below offers the magnetic recording medium which has on a support a substantially nonmagnetic lower layer and a magnetic upper layer containing hexagonal ferrite powder dispersed in a binder, and besides, the magnetic layer of which has a magnetic porosity of 15 to 30% by volume, a variation coefficient (σ/δ) of 30% or less with respect to the thickness thereof (wherein σ stands for a standard deviation of magnetic layer thickness and δ stands for a magnetic layer thickness) and a center-plane-average surface roughness Ra of 0.5 to 4 nm.

Although higher recording densities require recording capacities to be further increased, and therefore, giant magnetoresistive playback heads (the so-called GMR heads) much higher in sensitivity than anisotropic magnetoresistive playback heads (the so-called AMR heads) are offered at present, the magnetic recording medium disclosed in JP-A-2002-304716 causes a problem that it cannot achieve sufficient electromagnetic conversion characteristics by use of a GMR head.

In JP-A-2002-304716, though the minimum in the thickness range specified for the magnetic layer is 50 nm, the minimum of the magnetic layer thickness in Examples is 150 nm and this thickness is inadequate for higher-density recording. In addition, the variation coefficient of magnetic layer thickness is 12% at the minimum in Examples, so the standard deviation σ of the magnetic layer thickness is 18 nm at the minimum, which cannot be said to be sufficiently small.

Furthermore, the variation coefficient (σ/δ) with respect to the magnetic layer thickness JP-A-2002-304716, as described in the paragraphs (0009) and (0019), is determined from cross-section TEM (transmission electron microscopy) images of super-thin slices of the magnetic recording medium. The information about magnetic layer profiles obtained from TEM images is the average of pieces of information in the thickness direction of slices and has no consideration of precise information about the distribution of the magnetic substance in the thickness direction of the magnetic layer, notably at the interface between the magnetic layer and the nonmagnetic layer.

When the magnetic-substance distribution in the thickness direction of the magnetic layer is not uniform, there occurs a problem that output variations become great during the playback with a GMR head.

The foregoing magnetic-substance distribution in the thickness direction of the magnetic layer is inadequate for GMR heads which are sensitive to such a distribution, and it is required to specify the distribution.

### SUMMARY OF THE INVENTION

Therefore, an object of the invention is to provide a magnetic recording medium having suitability for use of a GMR head, which is reduced in thickness variations of its magnetic layer, and by extension in output variations, and what's more, which can ensure a high S/N ratio.

The following is an aspect of the invention.

1) A magnetic recording medium comprising:

a nonmagnetic support; and

a magnetic layer that comprises:
a binder; and
ferromagnetic powder dispersed in the binder,

wherein δ is 10 to 100 nm; and

σ_{d} is from 5 to 50 nm in terms of coating layer in the magnetic recording medium,

wherein δ represents an average thickness of the magnetic layer; and

σ_{d} represents a standard deviation that is obtained by measuring by TOF-SIMS a depth profile of an element present only in the magnetic layer among elements constituting the ferromagnetic powder and subjecting a differential curve of the depth profile to a normal distribution curve fitting.

2) The magnetic recording medium as described in 1),

wherein δ is 20 to 90 nm.

3) The magnetic recording medium as described in 1),

wherein δ is 30 to 80 nm.

4) The magnetic recording medium as described in 1),

wherein σ_{d} is from 5 to 40 nm in terms of coating layer in the magnetic recording medium.

5) The magnetic recording medium as described in 1),

wherein σ_{d} is from 5 to 20 nm in terms of coating layer in the magnetic recording medium.

### BRIEF DESCRIPTION OF THE DRAWING

FIG. 1 shows a depth profile curve of Ba as a constituent element of a magnetic layer, as is used for determination of σ_{d}; and

FIG. 2 shows a depth profile curve and a differential curve thereof in terms of sputter depth [nm] as abscissa, to which the sputter time [sec] as abscissa in FIG. 1 is converted by multiplying the sputter time by a sputter rate [nm/sec].

### DETAILED DESCRIPTION OF THE INVENTION

As a result of our study to solve the foregoing problem, it has been found that a matter of importance to the invention is to specify the average thickness δ of a magnetic layer and the standard deviation σ_{d} determined from a fitting of the differential curve of a depth profile measured by TOF-SIMS for a normal distribution (hereinafter also referred to as “σ_{d}”, or “standard deviation σ_{d} of magnetic powder distribution in the thickness direction at the interface”), and these specified values make it feasible to ensure uniform distribution of the magnetic powder in the depth direction of a magnetic layer, notably at the interface, to result in significant improvements in output variations and electromagnetic conversion characteristics.

In the invention, the average thickness of a magnetic layer and the standard deviation σ_{d} of magnetic powder distribution in the thickness direction can be attained by adopting a strategy as mentioned below:

a) using a support having excellent surface smoothness,

b) using a nonmagnetic layer having excellent surface smoothness, wherein the excellent surface smoothness can be imparted to the nonmagnetic layer, e.g., by performing thermal treatment at appropriate settings of temperature and treatment time after forming the nonmagnetic layer on a support or before forming a magnetic layer on the nonmagnetic layer or, prior to the thermal treatment, by further performing calender treatment under conditions that the temperature, pressure, speed, material, surface property and roll configuration of calender rolls are chosen as appropriate,

c) forming a subbing layer (smoothing layer) on a support and a nonmagnetic layer by use of a polymer or a radiation curable compound,

d) using a backing layer having excellent surface smoothness, wherein fine powder having good dispersibility is used in a coating composition for forming the backing layer (backing composition),

e) performing calender treatment under conditions that the temperature, pressure, speed, material, surface property and roll configuration of calender rolls are chosen as appropriate after forming the magnetic layer and the backing layer, or/and

f) applying a magnetic coating composition by means of a pulsation-free pump when forming the magnetic layer.

In the invention, the symbols δ and σ_{d} represent what are respectively defined in the EXAMPLE section.

The value of δ is from 10 to 100 nm, preferably from 20 to 90 nm, far preferably from 25 to 85 nm, especially preferably from 30 to 80 nm, and the value of σ_{d} is from 5 to 50 nm, preferably from 5 to 40 nm, far preferably from 5 to 30 nm, especially preferably 5 to 20 nm.

The respective components constituting the magnetic recording medium in the invention are described below.

<Nonmagnetic Support>

The nonmagnetic support usable in the invention is known film, with examples including films of polyesters, such as polyethylene terephthalate and polyethylene naphthalate, polyolefin, cellulose triacetate, polycarbonate, polyamide, polyimide, polyamideimide, polysulfone, polyaramide, aromatic polyamide and polybenzoxazole. Of these materials, high-strength supports, such as polyethylene naphthalate and polyamide, are preferred over the others. On the other hand, it is also possible to use the laminated support as disclosed in JP-A-3-224127 when the magnetic layer side and the nonmagnetic support side of a support are required to differ in surface roughness. These supports may undergo in advance corona discharge treatment, plasma treatment, ease-of-adhesion treatment, heat treatment or dust removal treatment. In addition, an aluminum or glass substrate can be employed as the support for use in the invention.

Of those supports, a polyester support (hereinafter referred to as polyester for short) is the best. Such polyester is polyester prepared from dicarboxylic acid and diol, such as polyethylene terephthalate or polyethylene naphthalate.

Examples of a dicarboxylic acid as a main constituent of polyester include terephthalic acid, isophthalic acid, phthalic acid, naphthalene-2,6-dicarboxylic acid, naphthalene-2,7-dicarboxylic acid, diphenyl sulfone dicarboxylic acid, diphenyl ether dicarboxylic acid, diphenylethanedicarboxylic acid, cyclohexanedicarboxylic acid, diphenyldicarboxylic acid, diphenyl thioether dicarboxylic acid, diphenyl ketone dicarboxylic acid and phenylindanedicarboxylic acid.

Example of a diol as the other main constituent include ethylene glycol, propylene glycol, tetramethylene glycol, cyclohexane dimethanol, 2,2-bis(4-hydroxyphenyl)propane, 2,2-bis(4-hydroxyethoxyphenyl)propane, bis(4-hydroxyphenyl)sulfone, bisphenol fluorenedihydroxyethyl ether, diethylene glycol, neopentyl glycol, hydroquinone and cyclohexanediol.

Of the polyesters containing those compounds as main constituents, polyesters containing terephthalic acid or/and naphthalene-2,6-dicarboxylic acid as main constituent dicarboxylic acids and ethylene glycol or/and cyclohexane-1,4-dimetanol as main constituent diols are preferred over the others from the viewpoints of transparency, mechanical strength and dimensional stability.

Of these polyesters, a polyester containing polyethylene terephthalate or polyethylene-2,6-naphthalate as a main constituent, a polyester copolymer of terephthalic acid, naphthalene-2,6-dicarboxylic acid and ethylene glycol, and a polyester containing as a main constituent a mixture of two or more of these polyesters are preferable by far. And polyesters containing polyethylene-2,6-naphthalate as a main constituent are especially favorable.

Additionally, the polyester for use in the invention may be a biaxially-stretched polyester, or a polyester laminate of two or more layers.

Further, the polyester used may be a polyester copolymer containing another copolymerized constituent, or a mixture with another polyester. Examples of such a copolymerized constituent and mixable polyester include those chosen from the dicarboxylic acids or diols as recited above, and polyesters prepared from them.

For the purpose of imparting delamination resistance to a polyester for use in the invention when it is in a film state, an aromatic dicarboxylic acid having a sulfonate group or an ester-forming derivative thereof, a dicarboxylic acid having a polyoxyalkylene group or an ester-forming derivative thereof, or a diol having a polyoxyalkylene group may be introduced as a copolymerized constituent into the polyester.

Compounds especially preferred among such copolymerized constituents in terms of polymerization reactivity and film transparency of polyester are 5-sodiumisulfoisophthalic acid, 2-sodiumsulfoterephthalic acid, 4-sodiumsulfophthalic acid, 4-sodiumsulfonaphthalene-2,6-dicarboxylic acid, compounds obtained by substituting other metals (e.g., potassium, lithium), ammonium salts or phosphanium salts for the sodium atoms in those acids or ester-forming derivatives of these compounds, and polyethylene glycol, polytetramethylene glycol, polyethylene glycol-polypropylene glycol copolymer and compounds obtained by converting each-end hydroxyl groups of these glycols into carboxyl groups through oxidation. The suitable proportion of compounds copolymerized for that purpose is from 0.1 to 10 mole % based on the dicarboxylic acids which constitute the polyester.

For the purpose of enhancing heat resistance, on the other hand, bisphenol compounds or compounds having naphthalene or cyclohexane rings can be introduced as copolymerizing constituents. The suitable proportion of such copolymerizing constituents is from 1 to 20 mole % based on the dicarboxylic acids which constitute the polyester.

There is no particular restriction as to the synthesis method of a polyester for use in the invention, but the polyester can be synthesized according to hitherto known methods. For instance, it is possible to adopt a direct esterification method in which a dicarboxylic acid and a diol are subjected directly to esterification, or a transesterification method in which polymerization is accomplished by using a dialkyl ester as a dicarboxylic acid constituent at the outset, making transesterification occur between this ester and a diol constituent, and then removing an excess of diol constituent by heating the reaction system under reduced pressure. Herein, a transesterification catalyst or a polymerization catalyst can be used or a heat-resisting stabilizer can be added, if needed.

In addition, one or more than one additive chosen from various ones, such as a coloration inhibitor, an antioxidant, a nucleation agent, a slipping agent, a stabilizer, a blocking inhibitor, a UV absorbent, a viscosity adjustment agent, a defoaming and clarifying agent, an antistatic agent, a pH adjustment agent, a dye, a pigment and a reaction stopping agent, may be added in any step of the synthesis.

Further, a filler may be added to a polyester for use in the invention. Examples of such a filler include inorganic powders, such as spherical silica, colloidal silica, titanium oxide and alumina, and organic fillers, such as cross-linked polystyrene and silicone resin.

For the purpose of imparting high stiffness to a support, a support material may be stretched to a high degree, or the surface thereof may be provided with a layer of metal, semimetal or oxide thereof.

The thickness of polyester film used as a nonmagnetic support in the invention is preferably from 3 to 80 μm, far preferably from 3 to 50 μm, particularly preferably from 3 to 10 μm. The center-plane average roughness (Ra) of the support surface is 4 nm or less, preferably 2 nm or less. These Ra values are determined with WYKO HD2000.

In addition, the Young's moduli of a nonmagnetic support in the length and width directions are preferably 6.0 GPa or above, far preferably 7.0 GPa or above.

The present magnetic recording medium is a material having on at least one side of the nonmagnetic support as mentioned above a magnetic layer made up of a ferromagnetic powder and a binder, preferably a material further having a substantially nonmagnetic layer (also referred to as subbing layer or nonmagnetic subbing layer) between the nonmagnetic support and the magnetic layer.

<Magnetic Layer>

The particle volume of ferromagnetic powder contained in the magnetic layer is preferably from 1,000 to 20,000 nm³, far preferably from 2,000 to 8,000 nm³. By adjusting the volume to such a range, not only degradation of magnetic characteristics by thermal fluctuations can be avoided effectively but also a satisfactory C/N(S/N) ratio can be attained as low noise is retained. The ferromagnetic powder, though it has no other particular restrictions, is preferably ferromagnetic metal powder, hexagonal ferrite powder or iron nitride powder.

When the powder is acicular powder, the particle volume is determined from the lengths of long and short axes on the assumption that the particles thereof are in the shape of a circular column.

When the powder is tabular powder, the particle volume is determined from the tablet diameter and the axial length (tablet thickness) on the assumption that the particles thereof are in the shape of a prism (a hexagonal column in the case of hexagonal ferrite powder).

In the case of iron nitride powder, the particle volume is determined under the assumption that the particles thereof is in the shape of a sphere.

The particle size of magnetic powder is measured in the following manner. To begin with, an appropriate amount of magnetic layer is scratched away. A 30 to 70 mg portion of the magnetic layer scratched away is admixed with n-butylamine, sealed in a glass tube, mounted in thermal decomposition apparatus, and then heated at 140° C. for about one day. After cooling, the contents in the glass tube are taken out, and separated into a liquid and a solid by centrifugation. The separated solid is washed with acetone, thereby obtaining a powdery sample for TEM measurement. This sample is mounted on a transmission electron microscope H-9000, made by Hitachi Ltd., and the particles therein are photographed under magnification of 100,000 times. Furthermore, photographs of the particles are printed on photographic printing papers from those photomicrographs at a setting that a total magnification of 500,000 is attained. The target magnetic substance is selected from the photographs of particles, the outlines of particles are traced with a digitizer, and the particle sizes are determined with the aid of an image analysis software KS 400, made by Carl Zeiss. Herein, the sizes of 500 particles are measured.

In the present specification, the fine particle size of a magnetic substance (hereinafter referred to as the fine particle size) is represented by (1) the length of a long axis that specifies the form of fine particles, or the long-axis length, when the fine particles are in the shape of a needle, a spindle or a column (provided that the height is greater than the longest span of the base), (2) the longest span of a top or bottom surface when the fine particles are in the shape of a tablet or a column (provided that the thickness or the height is smaller than the longest span), or (3) the circle-equivalent diameter when the fine particles have a spherical, polyhedral or irregular shape and the long axes thereof cannot be determined from the shape. The term “circle-equivalent diameter” as used herein refers to the diameter determined from the circle equal to a projected area.

Additionally, the average diameter of fine particles of the foregoing powder is the arithmetic mean of the foregoing fine particle sizes, and determined by making the measurements described above on 500 primary particles. The term “primary particles” refers to the agglomeration-free independent fine particles.

Moreover, the average acicular ratio of the fine particles refers to the arithmetic mean of long-axis length/shot-axis length ratios of the fine particles, which are calculated by further determining the lengths of short axes of the fine particles, or the short-axis lengths, in the foregoing measurements. Herein, the term “short-axis length” refers to the length of a short axis that specifies the form of fine particles in the case (1) and the thickness or the height in the case (2), respectively, in the foregoing definitions for the fine particle size. In the case (3), on the other hand, no distinction can be made between the long axis and the short axis, so the long-axis length/short-axis length ratio is assumed to be 1 for the sake of convenience.

In the case of fine particles having a specific shape, e.g., the shape corresponding with the particle size definition (1), the average fine particle size is termed “average long-axis length”; in the case of fine particles having the shape corresponding with the definition (2), the average fine particle size is termed “average tablet diameter” and the arithmetic mean of longest diameter/thickness (or height) ratios is termed “average tabular ratio”; and in the case of fine particles having the shape corresponding with the definition (3), the average fine particle size is termed “average diameter (or average particle size, or average particle diameter as well)”. In the particle size measurements, the standard deviation/average value ratio expressed as a percentage is defined as the variation coefficient.

<Ferromagnetic Metal Powder>

The ferromagnetic metal powder used in the magnetic layer of the present magnetic recording medium has no particular restriction so far as its main constituent is Fe (including Fe alloy), but it is preferably ferromagnetic alloy powder containing α-Fe as a main constituent. This ferromagnetic powder may further contain atoms other than the specified atom, such as Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr and B. Besides α-Fe, the ferromagnetic powder preferably contain at least one atom chosen from Al, Si, Ca, Y, Ba, La, Nd, Co, Ni or B, and among these atoms the incorporation of Co, Al and Y is especially preferred. More specifically, Co, Al and Y is incorporated in amounts of 10 to 40 atomic %, 2 to 20 atomic % and 1 to 15 atomic %, respectively, based on Fe.

Before being dispersed, the ferromagnetic metal powder as recited above may be treated with a dispersant, a lubricant, surfactant or/and an antistatic agent. These treatment agents are described hereinafter. In addition, the ferromagnetic metal powder may contain a small amount of water, hydroxide or oxide. Herein, the water content in the ferromagnetic metal powder is preferably controlled to a range of 0.01 to 2%. And it is appropriate that the water content in the ferromagnetic metal powder be optimized according to the type of binder used together. The pH of the ferromagnetic metal powder is preferably optimized according to what type of binder is used in combination therewith. The pH range is generally from 6 to 12, preferably from 7 to 11. There may be cases where the ferromagnetic metal powder contains any of water-soluble inorganic ions, such as Na, Ca, Fe, Ni, Sr, NH₄, SO₄, Cl, NO₂ and NO₃ ions. However, these ions are preferably absent in a substantial sense. So long as the total content of those ions is on the order of 300 ppm or less, they have little influence on characteristics of ferromagnetic metal powder. Moreover, it is preferable that the ferromagnetic metal powder used in the invention has lower porosity, and more specifically, the porosity is at most 20% by volume, preferably at most 5% by volume.

The long-axis length of ferromagnetic metal powder is preferably from 10 to 100 nm, far preferably from 20 to 70 nm, particularly preferably from 30 to 60 nm.

The crystallite size of ferromagnetic metal powder is preferably from 70 to 180 Å, far preferably from 80 to 140 Å, particularly preferably from 90 to 130 Å.

Such a crystallite size is an average value calculated from the half-widths of diffraction peaks in accordance with Scherrer method, wherein the diffraction peaks are peaks measured with X-ray diffraction instrument (RINT 2000 Series, made by Rigaku Corporation) under conditions that the radiation source is CuKα1, the X-ray tube voltage is 50 kV and the X-ray tube current is 300 mA.

The specific surface area (SBET) of ferromagnetic metal powder, as determined by BET method, is preferably in a range of 45 to 120 m²/g, far preferably 50 to 100 m²/g. It is not desirable that the SBET value falls outside such a range, because SBET values smaller than 45 m²/g become a cause of high noise and SBET values greater than 120 m²/g make it difficult to ensure good surface properties. As far as the SBET value falls within the foregoing range, good surface properties and low noise can be achieved at the same time.

By undergoing surface treatment, the ferromagnetic metal powder may have a surface formed of Al, Si, P or an oxide thereof. The amount of such a surface is from 0.1 to 10% based on the ferromagnetic powder. It is advantageous to perform the surface treatment since the adsorption of a lubricant, such as fatty acid, can be reduced to 100 mg/m² or less.

The ferromagnetic metal powder may have any of shapes, including acicular, cubic, rice-grain and tabular shapes, so far as the particle volume requirement specified above is satisfied, but it is especially preferable to use acicular ferromagnetic powder. In the case of acicular ferromagnetic metal powder, the average acicular ratio is preferably from 4 to 12, far preferably from 5 to 8. The coercive force (Hc) of ferromagnetic metal powder is preferably from 159.2 to 278.5 kA/m (2,000 to 3,500 Oe), far preferably from 167.1 to 238.7 kA/m (2,100 to 3,000 Oe). In addition, the saturation flux density is preferably from 150 to 300 mT (1,500 to 3,000 G), far preferably from 160 to 290 mT, and the saturation magnetization (as) is preferably from 90 to 140 μm²/kg (90 to 140 emu/g), far preferably from 100 to 120 μm²/kg. As to the SFD (switching field distribution) of the magnetic substance in itself, the smaller the better. Specifically, the SFD of 0.6 or less is preferred. When the SFD is 0.6 or less, it is possible to achieve good electromagnetic conversion characteristics, high output, sharp magnetic reversal and small peak shift which are suitable for high-density digital magnetic recording. As methods for obtaining a limited distribution of Hc, improvement of the particle size distribution of Goethite, use of monodisperse α-Fe₂O₃ and prevention of sintering between particles are usable.

Ferromagnetic metal powders obtained by known manufacturing methods can be used in the invention, and more specifically, the following methods are applicable. Such known methods include a method in which hydrous iron oxide or iron oxide undergoing anti-sintering treatment is reduced with a reducing gas, such as hydrogen, and converted into Fe or Fe—Co particles; a method in which a compound organic acid salt (mainly including an oxalic acid salt) is reduced with a reducing gas, such as hydrogen; a method in which a metal carbonyl compound is decomposed by heat; a method in which reduction is performed by adding a reducing agent, such as sodium borohydride, hydrophosphite or hydrazine, to a water solution of ferromagnetic metal; and a method in which metal is evaporated into power under low-pressure inert gas atmosphere. The ferromagnetic metal powders thus obtained are subjected to known slow-oxidation treatment. For instance, a method of reducing hydrous iron oxide or iron oxide with a reducing gas, such as hydrogen, and forming an oxide film on the iron particle surface while controlling the partial pressures of oxygen-containing gas and inert gas, the temperature and the time is preferred in point of small demagnetization.

<Ferromagnetic Hexagonal Ferrite Powder>

Examples of ferromagnetic hexagonal ferrite powder include barium ferrite, strontium ferrite, lead ferrite, calcium ferrite, and these ferrites having undergone partial replacement of their respective metals by Co. More specifically, there are barium ferrite and strontium ferrite with magnetoplumbite structures, ferrites with magnetoplumbite structures whose particle surfaces are covered with Spinel structures, and barium ferrite and strontium ferrite with magnetoplumbite structures in which Spinel phases are included. These ferrites may further contain atoms other than the specified atoms, such as Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge and Nb. In general, it is possible to use ferrite to which is added a combination of elements, such as Co—Zn, Co—Ti, Co—Ti—Zr, Co—Ti—Zn, Ni—Ti—Zn, Nb—Zn—Co, Sb—Zn—Co or Nb—Zn. Atoms preferably added and their contents are similar to those in the case of ferromagnetic metal powder.

The particle sizes of hexagonal ferrite powder are preferably those meeting the foregoing volume condition, and the average tablet diameter is from 10 to 50 nm, preferably from 15 to 40 nm, far preferably from 20 to 30 nm.

The average tabular ratio is from 1 to 15, preferably from 1 to 7. When the average tabular ratio is from 1 to 15, sufficient alignment can be attained in a magnetic layer as high degree of packing is retained, what's more an increase of noise due to stacking of particles can be suppressed. In addition, when the particle sizes are within the foregoing range, the specific surface area (SBET) determined by BET method is preferably 40 m²/g or above, far preferably from 40 to 200 m²/g, particularly preferably from 60 to 100 m²/g.

In general, the narrower distributions the hexagonal ferrite powder has with respect to its particulate tablet diameters and thicknesses, the better results the hexagonal ferrite powder can produce. Conversion of particulate tablet diameter and thickness into numbers can be made by randomly selecting 500 particles from TEM photographs of particles, and carrying out measurements on the selected particles and performing comparisons among them. The distributions of particulate tablet diameters and thicknesses are not normal distributions in many cases, but the value of σ/average size is from 0.1 to 1.0 when they are calculated and expressed in standard deviation with respect to the average size. In order to make the particle size distribution sharp, not only the reaction system for particle formation is made as homogeneous as possible, but also the particles formed are subjected to distribution improving treatment. For instance, the method of selectively dissolving superfine particles in an acid solution is known.

The coercive force (Hc) of hexagonal ferrite powder can be brought into the range of 143.3 to 318.5 kA/m (1,800 to 4,000 Oe), preferably 159.2 to 238.9 kA/m (2,000 to 3,000 Oe), far preferably 191.0 to 214.9 kA/m (2,200 to 2,800 Oe). The coercive force (Hc) can be controlled by particle dimensions (tablet diameter and thickness), the kinds and amounts of contained elements, substitution sites of elements and reaction conditions for particle formation.

The saturation magnetization (σs) of hexagonal ferrite powder is from 30 to 80 A·m²/kg (emu/g). As to the saturation magnetization, the higher the better. However, there is a tendency that the finer the particles the lower the saturation magnetization. For improvement of the saturation magnetization, it is well known to combine magnetoplumbite ferrite with Spinel ferrite, or choose the kinds and amounts of contained elements. Alternatively, it is possible to use W-type hexagonal ferrite. Prior to dispersion of magnetic particles, it is also carried out to treat the particle surfaces with a material appropriate to a dispersion medium and a polymer used together with the particles. As the surface treatment agent, both inorganic and organic compounds can be used. Typical examples of such compounds include oxides or hydroxides of Si, Al and P, various silane coupling agents and various titan coupling agents. The addition amount of such a surface treatment agent is from 0.1 to 10 mass % based on the magnetic material. The pH of the magnetic material is also important for dispersion. Although the optimal pH is generally within the range of 4 to 12 though it depends on the dispersion medium and the polymer, the pH on the order of 6 to 11 is selected from the viewpoints of chemical stability and keeping quality. The moisture content in the magnetic material has also effect on dispersion. The optimal moisture content, though depends on the dispersion medium and the polymer, is generally selected from the range of 0.01 to 2.0%.

As methods for manufacturing hexagonal ferrite powder, there are known (1) a glassy crystallization method in which barium oxide, iron oxide, metal oxides for iron substitution and boron oxide as a glass forming material are mixed in amounts making the intended ferrite composition possible, molten and then quenched to give an amorphous matter, and the amorphous matter is further subjected to successive heating, washing and grinding treatments, thereby obtaining barium ferrite crystalline powder, (2) a hydrothermal reaction method in which a solution of metal salt mixture of a barium ferrite composition is neutralized with an alkali, and therefrom bi-products are eliminated, then the liquid phase is heated at a temperature of 100° C. or above, and further subjected to washing, drying and grinding, thereby obtaining barium ferrite crystalline powder, and (3) a coprecipitation method in which a hydrothermal reaction method in which a solution of metal salt mixture of a barium ferrite composition is neutralized with an alkali, and therefrom bi-products are eliminated, further the resulting solution is dried and undergoes treatment at a temperature of 1,100° C. or less, and then ground, thereby obtaining barium ferrite crystalline powder. The invention may adopt any of those methods. The hexagonal ferrite powder may undergo surface treatment with Al, Si, P or an oxide thereof, if needed. The amount of such a surface treatment agent is from 0.1 to 10% based on the ferromagnetic powder, and the surface treatment is favorable because the adsorption of lubricant, such as fatty acid, is reduced to 100 mg/m² or less. There is a case in which a soluble inorganic ion, such as Na, Ca, Fe, Ni or Sr, is contained in ferromagnetic powder. Although it is preferable that such ions are absent in a substantial sense, they have negligible effect on characteristics so far as their content is 200 ppm or less.

<Magnetic Iron Nitride Particles>

As to the magnetic iron nitride particles, the term “the average particle diameter of Fe₁₆N₂ phase” in the case where a layer is formed on a Fe₁₆N₂ particle surface refers to the average diameter of Fe₁₆N₂ particles themselves, exclusive of their respective layers.

The magnetic iron nitride particles according to the invention contain at least a Fe₁₆N₂ phase, and it is preferable that other phases of iron nitride are not contained therein. This is because the crystalline magnetic anisotropy of iron nitride is on the order of 1×10⁵ erg/cc in Fe₄N and Fe₃N phases, while the Fe₁₆N₂ phase has high crystalline magnetic anisotropy of from 2×10⁶ to 7×10⁶ erg/cc. Accordingly, a high coercive force can be retained even when iron nitride is formed into fine particles. Such a high crystalline magnetic anisotropy is ascribable to the crystal structure of Fe₁₆N₂ phase. This crystal structure is a body-centered tetragonal structure wherein N atoms systematically intrude themselves on interstitial positions of octahedral lattice of Fe, and the distortion caused by intrusion of N atoms into the lattice is thought to be a source of high crystalline magnetic anisotropy. The axis of easy magnetization in the Fe₁₆N₂ phase is the c axis lengthened by nitriding.

The particles containing Fe₁₆N₂ phases are preferably spherical or ellipsoidal in shape, far preferably spherical in shape. This is because, when particles are acicular in shape, they have a disadvantage that, since one direction of three equivalent directions of α-Fe as cubic crystal is selected by nitriding and becomes c axis (axis of easy magnetization), particles having their axes of easy magnetization in the short-axis and long-axis directions, respectively, are present as a mixture. Therefore, the average of long-axis length/short-axis length ratios is preferably 2 or less (e.g., from 1 to 2), far preferably 1.5 or less (e.g., from 1 to 1.5).

The diameters of iron nitride particles are determined by the diameters of iron particles before undergoing nitriding, and the distribution thereof is preferably monodisperse. This is because the monodisperse distribution generally contributes to reduction in medium noise. And the particle diameter of iron nitride-type magnetic powder whose main phase is Fe₁₆N₂ is determined by the diameter of iron particles, and the diameter distribution of iron particles is preferably monodisperse. This is because the nitriding degree differs between large-sized and small-sized particles, and thereby variations in magnetic characteristics are caused. In this sense also, it is preferable that the particle diameter distribution of iron nitride-type magnetic powder is monodisperse.

The particle diameter of Fe₁₆N₂ phase as a magnetic substance is from 9 to 11 nm. This is because, when the particle diameter is below such a range, thermal fluctuations have a great influence on the phase; as a result, the phase comes to have super paramagnetism and becomes unsuitable for magnetic recording media. In addition, the particle diameters below the foregoing range cause an increase in coercive force at the time of high-speed recording with a head because of magnetic viscosity; as a result, the recording becomes hard to perform. When the particle diameter is beyond the foregoing range, on the other hand, it becomes difficult to perform the recording because the saturation magnetization cannot be made small, and so the coercive force at the time of recording becomes too great. In addition, the particles large in size cause an increase in particle noise when used in a magnetic recording medium. So the particle diameter distribution is preferably monodisperse. This is because the monodisperse distribution can generally reduce medium noise. The variation coefficient of particle diameter is 15% or less (preferably from 2 to 15%), far preferably 10% or less (especially from 2 to 10%).

The surface of iron nitride-type magnetic powder containing Fe₁₆N₂ as a main phase is preferably covered with an oxide film. This is because particulate Fe₁₆N₂ is subject to oxidation and requires to be handled in an atmosphere of nitrogen.

It is preferable that the oxide film contains an element or elements chosen from rare earth elements, silicon or aluminum. By containing such elements, the powder can have particulate surfaces similar to those of currently used powders containing Fe and Co as main constituents, or the so-called metal powders, and an affinity for the process in which the metal powders are handled is enhanced. Examples of rare earth elements which can be used to advantage include Y, La, Ce, Pr, Nd, Sm, Tb, Dy and Gd. Of these elements, Y is preferred over the others from the viewpoint of dispersibility.

Besides silicon and aluminum, boron and phosphorus may be incorporated, if needed. In addition, carbon, calcium, magnesium, zirconium, barium and strontium may be incorporated as effective elements. By combined use of these other elements and rare earth elements, or/and silicon, or/and aluminum, higher shape retention properties and dispersion capability can be obtained.

Where the composition of the surface compound layer is concerned, the total content of rare earth elements, boron, silicon, aluminum and phosphorus is preferably from 0.1 to 40.0 atomic %, far preferably from 1.0 to 30.0 atomic %, further preferably from 3.0 to 25.0 atomic %, based on iron. When the content of those elements is too low, it becomes difficult to form a surface compound layer to result in not only reduction in magnetic anisotropy of the magnetic powder but also deterioration in oxidation stability of the magnetic powder. When the content of those elements is too high, on the other hand, too large a drop in saturation magnetization tends to occur.

The thickness of such an oxide film is preferably from 1 to 5 nm, far preferably from 2 to 3 nm. This is because it tends to occur that the oxide film of a thickness below such a range hardly contributes oxidation stability, while the thickness beyond the range makes it difficult to substantially reduce the particle size.

As to the magnetic characteristics of iron nitride-type magnetic particles whose main phase is Fe₁₆N₂, the coercive force (Hc) of these particles is preferably from 79.6 to 318.4 kA/m (1,000 to 4,000 Oe), far preferably from 159.2 to 278.6 kA/m (2,000 to 3,500 Oe), further preferably from 197.5 to 237 kA/m (2,500 to 3,000 Oe). This is because it tends to occur that low Hc values are unsuitable for high-density recording because they cause adjacent recording bits to be susceptible to each other in the case of longitudinal magnetic recording, while too high Hc values cause difficulty in making recordings.

The saturation magnetization is preferably from 80 to 160 Am²/kg (80 to 160 emu/g), far preferably from 80 to 120 Am²/kg (80 to 120 emu/g). This is because it sometimes occurs that, when the saturation magnetization is too low, the signals produced are weak, while too high saturation magnetization causes adjacent recording bits to be susceptible to each other in the case of longitudinal magnetic recording and impairs suitability for high-density recording. The squareness ratio is preferably from 0.6 to 0.9.

In addition, the BET specific surface area of this magnetic powder is preferably from 40 to 100 m²/g. This is because, when the BET specific surface area is too small, the particles are large in size and cause a high level of particle noise when used in a magnetic recording medium, and besides, they lower the surface smoothness of magnetic layer and tend to cause a drop in reproduction output. When the BET specific surface area is too large, on the other hand, the particles containing the Fe₁₆N₂ phase are apt to cling together, so they are hard to disperse homogeneously and make it difficult to form a smooth surface.

The average particle size of iron nitride powder is, as is described above, 30 nm or less, and it is preferably from 5 to 25 nm, far preferably from 10 to 20 nm.

In manufacturing magnetic particles of iron nitride, known techniques can be applied. For instance, the method disclosed in WO 2003/079332 can be referred to.

The magnetic particles manufactured by the above-mentioned manufacturing method are suitably used in the magnetic layer of a magnetic recording medium. Examples of such a magnetic recording medium include magnetic tapes, such as a video tape and a computer tape; and magnetic disks, such as a floppy™ disk and a hard disk.

<Binder>

In the present magnetic recording medium, known techniques for magnetic and non-magnetic layers can be applied to binders, lubricants, dispersants, additives, solvents and dispersion methods for use in magnetic and nonmagnetic layers, respectively, as appropriate. Known techniques concerning the binder amount and kind, the additives and the dispersant amount and kind in particular are applicable.

Examples of a binder for use in the invention include hitherto known thermoplastic resins, thermosetting resins, reactive resins and mixtures thereof. The thermoplastic resins usable in the invention are those having their glass transition temperatures in the range of −100 to 150° C., their number-average molecular weights in the range of 1,000 to 200,000, preferably 10,000 to 100,000, and their polymerization degrees in the range of about 50 to about 1,000.

Examples of such thermoplastic resins include homo- or co-polymers containing vinyl chloride, vinyl acetate, vinyl alcohol, maleic acid, acrylic acid, acrylate, vinylidene chloride, acrylonitrile, methacrylic acid, methacrylate, styrene, butadiene, ethylene, vinyl butyral, vinyl acetal or vinyl ether as structural units, polyurethane resin and various rubber resins. Examples of thermosetting resins or reactive resins include a phenol resin, an epoxy resin, a cure-type polyurethane resin, an urea resin, a melamine resin, an alkyd resin, an acrylic reactive resin, a formaldehyde resin, a silicone resin, an epoxy-polyamide resin, a mixture of polyester resin and isocyanate prepolymer, a mixture of polyester polyol and polyisocyanate, and a mixture of polyurethane and polyisocyanate. Details of these resins are described, e.g., in Plastic Binran (Handbook on Plastics), published by Asakura Publishing Co., Ltd. Alternatively, it is possible to use a known electron-beam cure resin in each layer. Examples of such a resin and a manufacturing method thereof are described in detail in JP-A-62-256219. Although the resins as recited above can be used alone or in combination, it is preferable that at least one resin selected from vinyl chloride resins, vinyl chloride/vinyl acetate copolymers, vinyl chloride/vinyl acetate/vinyl alcohol copolymers or vinyl chloride/vinyl acetate/maleic anhydride copolymers is used in combination with a polyurethane resin, or such a combination is further combined with polyisocyanate.

Where the structure of the polyurethane resin is concerned, any of known ones, such as polyester polyurethane, polyether polyurethane, polyether polyester polyurethane, polycarbonate polyurethane, polyester polycarbonate polyurethane and polycaprolactone polyurethane, can be used. For imparting more excellent dispersibility and durability to each of the binders recited above, it is favorable to introduce at least one polar group selected from —COOM, —SO₃M, —OSO₃M, —P═O(OM)₂, —O—P═O(OM)₂ (Up to this group, M represents a hydrogen atom or an alkali metal base), —OH, —NR₂, —N⁺R₃ (R is a hydrocarbon residue), an epoxy group, —SH or —CN into each binder by copolymerization or addition reaction on an as needed basis. The amount of such a polar group introduced is from 10⁻¹ to 10⁻⁸ mole/g, preferably from 10⁻² to 10⁻⁶ mole/g.

Concrete examples of those binders usable in the invention include VAGH, VYHH, VMCH, VAGF, VAGD, VROH, VYES, VYNC, VMCC, XYHL, XYSG, PKHH, PKHJ, PKHC and PKFE, all of which are products of The Dow Chemical Company; MPR-TA, MPR-TA5, MPR-TAL, MPR-TSN, MPR-TMF, MPR-TS, MPR-TM and MPR-TAO, all of which are products of Nissin Chemical Industry Co., Ltd.; 1000W, DX80, DX81, DX82, DX83 and 100FD, all of which are products of Denki Kagaku Kogyo Kabushiki Kaisha; MR-104, MR-105, MR110, MR100, MR555 and 400X-110A, all of which are products of Zeon Corporation; Nipporan N2301, N₂₃O₂ and N₂₃O₄, all of which are products of Nippon Urethane Industry Co., Ltd.; PANDEX T-5105, T-R3080 and T-5201, BURNOCK D-400 and D-210-80, and CRISVON 6109 and 7209, all of which are products of Dainippon Ink and Chemicals, Incorporated; Vylon UR8200, UR8300, UR8700, RV530 and RV280, all of which are products of Toyobo Co., Ltd.; DAIFERAMINE 4020, 5020, 5100, 5300, 9020, 9022 and 7020, all of which are products of Dainichiseika Color and Chemicals Mfg. Co., Ltd.; MX5004, which is a product of Mitsubishi Chemical Corporation; Sanprene SP-150, which is a product of Sanyo Chemical Industries, Ltd.; and Saran F310 and F210, which are products of Asahi Kasei Corporation.

The binders for use in the nonmagnetic layer and the magnetic layer according to the invention are incorporated in amounts of 5 to 50 mass %, preferably 10 to 30 mass %, based on the nonmagnetic powder and the magnetic powder, respectively. Although it is preferable that 5 to 30 mass % of vinyl chloride resin, 2 to 20 mass % of polyurethane resin and 2 to 20 mass % of polyisocyanate are used in combination, only polyurethane or a polyurethane/isocyanate combination may be used when head corrosion is caused by slight dechlorination. It is advantageous for polyurethane used in the invention to have a glass transition temperature of −50° C. to 150° C., preferably 0° C. to 100° C., breaking elongation of 100% to 2,000%, rupture stress of 0.05 to 10 Kg/mm² (0.49 to 98 MPa) and a yield point of 0.05 to 10 Kg/mm² (0.49 to 98 MPa).

Examples of polyisocyanate usable in the invention include isocyanates, such as tolylene diisocyanate, 4,4′-diphenylmethane diisocyanate, hexamethylene diisocyanate, xylylene diisocyanate, naphthylene-1,5-diisocyanate, o-toluidine diisocyanate, isophorone diisocyanate and triphenylmethane triisocyanate; products from these isocyanates and polyhydric alcohol; and polyisocyanates produced by condensation of those isocyanates. Examples of trade names under which those isocyanates are marketed include Coronate L, Coronate HL, Coronate 2030, Coronate 2031, Millionate MR and Millionate MTL, which are products of Nippon Polyurethane Industry Co., Ltd.; Takenate D-102, Takenate D-110N, Takenate D-200 and Takenate D-202, which are products of Takeda Pharmaceutical Company Limited; and Desmodule L, Desmodule IL, Desmodule N and Desmodule HL, which are products of Sumitomo Bayer Urethane Co., Ltd. In each layer, these products can be used alone or in combination of two or more thereof by making use of a difference in their curing reactivities.

To the magnetic layer in the invention, additives can be added as required. Examples of such additives include an abrasive, a lubricant, a dispersant, a dispersion aid, a fungicide, an antistatic agent, an antioxidant, a solvent, and carbon black. More specifically, the compounds usable as those additives include molybdenum disulfide, tungsten disulfide, graphite, boron nitride and graphite fluoride; silicone oil, silicones with polar groups, silicones modified with fatty acids and fluorine-containing silicones; fluorine-containing alcohol, fluorine-containing esters, polyolefin, polyglycol and polyphenyl ether; aromatic ring-containing organic phosphonic acids, such as phenylphosphonic acid, benzylphosphonic acid, phenethylphosphonic acid, α-methylbenzylphosphonic acid, 1-methyl-1-phenethylphosphonic acid, diphenylmethylphoshonic acid, biphenylphosphonic acid, benzylphenylphosphonic acid, α-cumylphosphonic acid, toluoylphosphonic acid, xylylphosphonic acid, ethylphenylphosphonic acid, cumenylphosphonic acid, propylphenylphosphonic acid, butylphenylphosphonic acid, heptylphenylphosphonic acid, octylphenylphosphonic acid and nonylphenylphosphonic acid, and alkali metal salts thereof; alkylphosphonic acids, such as octylphosphonic acid, 2-ethylhexylphosphonic acid, isooctylphosphonic acid, isononylphosphonic acid, isodecylphosphonic acid, isoundecylphosphonic acid, isododecylphosphonic acid, isohexadecylphosphonic acid, isooctadecylphosphonic acid and isoeicosylphosphonic acid, and alkali metal salts thereof; aromatic phosphates, such as phenyl phosphate, benzyl phosphate, phenethyl phosphate, α-methylbenzyl phosphate, 1-methyl-1-phenethyl phosphate, diphenylmethyl phosphate, biphenyl phosphate, benzylphenyl phosphate, α-cumyl phosphate, toluoyl phosphate, xylyl phosphate, ethylphenyl phosphate, cumenyl phosphate, propylphenyl phosphate, butylphenyl phosphate, heptylphenyl phosphate, octylphenyl phosphate and nonylphenyl phosphate, and alkali metal salts thereof; alkyl phosphates, such as octyl phosphate, 2-ethylhexyl phosphate, isooctyl phosphate, isononyl phosphate, isodecyl phosphate, isoundecyl phosphate, isododecyl phosphate, isohexadecyl phosphate, isooctadecyl phosphate and isoeicosyl phosphate, and alkali metal salts thereof; alkyl sulfonates and alkali metal salts thereof; fluorine-containing alkylsulfates and alkali metal salts thereof; 10-24 C monobasic fatty acids which may contain unsaturated bonds and may have branched structures, such as lauric acid, myristic acid, palmitic acid, stearic acid, behenic acid, butyl stearate, oleic acid, linoleic acid, linolenic acid, elaidic acid and erucic acid, and metal salts thereof; monofatty acid esters, difatty acid esters or polyfatty acid esters prepared from 10-24 C monobasic fatty acids which may contain unsaturated bonds and may have branched structures, such as butyl stearate, octyl stearate, amyl stearate, isooctyl stearate, octyl myristate, butyl laurate, butoxyethyl stearate, anhydrosorbitan monostearate and anhydrosorbitan tristearate, and any one compound chosen from 2-22 C mono- to hexa-hydric alcohol compounds which may contain unsaturated bonds and may have branched structures, 12-22 C alkoxyalcohol compounds which may contain unsaturated bonds and may have branched structures or monoalkyl ethers of alkylene oxide polymers; 2-22 C fatty acid amides, and 8-22 C aliphatic amines. Instead of having the hydrocarbon groups as recited above, compounds having alkyl groups, aryl groups or aralkyl groups substituted with groups other than the hydrocarbon groups, such as a nitro group, F, Cl, Br and halogenated hydrocarbon groups including CF₃, CCl₃ and CBr₃, may be used.

In addition, nonionic surfactants derived from alkylene oxide, glycerin, glycidol and alkylphenol-ethylene oxide adducts, respectively; cationic surfactants, such as cyclic amines, ester amides, quaternary ammonium salts, hydantoin derivatives, heterocyclic compounds, phosphonium salts and sulfonium salts; anionic surfactants containing acidic groups, such as carboxylate, sulfonate and sulfate groups; and amphoteric surfactants, such as amino acids, aminosulfonic acids, and sulfates or phosphates of aminoalcohols, can also be used. Detailed descriptions of these surfactants can be found, e.g., in Kaimen Kasseizai Binran (Handbook on Surfactants), published by Sangyo Tosho Kabushiki Kaisha.

The lubricants and antistatic agents as recited above are not necessarily required to be pure, but they may contain impurities, such as isomers, unreacted materials, by-products, decomposed matter and oxidized matter, besides main components. The content of such impurities is preferably 30 mass % or less, far preferably 10 mass % or less.

Concrete examples of these additives include NAA-102, castor oil, hydrogenated fatty acid, NAA-42, CATION SA, NYMEEN L-201, NONION E-208, ANON BF and ANON LG, which are produced by NOF Corporation; FAL-205 and FAL-123, which are products of Takemoto Oil & Fat Co., Ltd.; NJLUB OL produced by New Japan Chemical Co., Ltd.; TA-3 produced by Shin-Etsu Chemical Co., Ltd.; ARMID P and DUOMEEN TDO produced by LION Corporation; BA-41G produced by Nisshin Oillio Group, Ltd.; and PROFAN 2012E, NEWPOL PE61 and IONET MS-400 produced by Sanyo Chemical Industries, Ltd.

Further, carbon black can be added to the magnetic layer in the invention, if needed. Examples of carbon black usable in the magnetic layer include furnace black for rubber use, thermal black for rubber use, carbon black for color use and acetylene black. It is advantageous for the carbon black used to have a specific surface area of 5 to 500 m²/g, a DBP oil absorption of 10 to 400 ml/100 g, a particle diameter of 5 to 300 nm, a pH value of 2 to 10, a moisture content of 0.1 to 10%, and a tap density of 0.1 to 1 g/ml.

Concrete examples of carbon black usable in the invention include BLACKPEARLS 2000, 1300, 1000, 900, 800, 880 and 700, and VULCAN XC-72, which are products of Cabot Co.; #80, #60, #55, #50 and #35, which are products of Asahi Carbon Co., Ltd.; #2400B, #2300, #900, #1000, #30, #40 and #10B, which are products of Mitsubishi Chemical Industries Ltd.; CONDUCTEX SC, RAVEN 150, 50, 40 and 15, and RAVEN-MT-P, which are products of Colombia Carbon Co.; and KETJENBLACK EC produced by Ketjen Black International Company. Prior to the use of carbon black, the carbon black may be surface-treated with a dispersant, a resin may be grafted onto the carbon black, or the carbon black surface may be partly converted into graphite. Alternatively, carbon black may be dispersed into a binder before it is added to a magnetic coating composition. The various kinds of carbon black as recited above may be used alone or as combinations. The suitable amount of carbon black used is from 0.1 to 30 mass % based on the magnetic substance. Carbon black in a magnetic layer can perform a function of preventing electrification, reducing the friction coefficient, imparting lightproof property, or/and enhancing the film strength, and which function(s) the carbon black can perform depends on its kind. In the invention, therefore, the kinds, amounts and combination of carbon black products to be used in magnetic and nonmagnetic layers can be naturally changed to suit the intended purpose on the basis of the various characteristics given above, including particle size, oil absorption, conductivity and pH. If anything, those are to be optimized in each layer. Details of carbon black usable in the magnetic layer according to the invention can refer to, e.g., Carbon Black Binran (Handbook on Carbon Black), compiled by Carbon Black Association.

<Abrasives>

Examples of an abrasive usable in the invention include known materials, most of which have Mohs' hardness of at least 6, such as aluminum oxide having an α-alumina content of at least 90%, β-alumina, silicon carbide, chromium oxide, cerium oxide, α-iron oxide, corundum, artificial diamond, silicon nitride, silicon carbide, titanium carbide, titanium dioxide, silicon dioxide and boron nitride, and these substances may be used alone or as combinations thereof. Further, those abrasives may be used in the form of complex (obtained by treating the surface of one abrasive with another abrasive). Although those abrasives sometimes contain compounds or elements other than their main components, they can function as abrasives so far as the proportion of their respective main components is not lower than 90 weight %. The suitable average particle size of those abrasives is from 0.01 to 2 μm. In order to enhance electromagnetic conversion characteristics in particular, it is advantageous that those abrasives have narrow particle size distributions. For enhancement of durability, on the other hand, abrasives having different particle sizes may be combined as required, or effects similar thereto may be attained by independent use of an abrasive having a broadened particle-size distribution. It is appropriate that the abrasives used in the invention have their tap density in the range of 0.3 to 2 g/cc, their moisture content in the range of 0.1 to 5%, their pH in the range of 2 to 11 and their specific surface area in the range of 1 to 30 m²/g. The abrasives may have any of acicular, spherical, cubic and tabular shapes. However, shapes having edges in part are advantageous from the viewpoint of abrasive capability. Examples of commercially available abrasives include AKP-12, AKP-15, AKP-20, AKP-30, AKP-50, HIT-20, HIT-30, HIT-55, HIT-60, HIT-70, HIT-80 and HIT-100, which are products of Sumitomo Chemical Co., Ltd.; ERC-DBM, HP-DBM and HPS-DBM, which are products of Reynolds Co.; WA10000, a product of Fujimi Corporation; UB20, a product of Uemura Kogyo & Co., Ltd.; G-5, Kuromex U2 and Kuromex U1, products of Nippon Chemical Industrial Co., Ltd.; TF100 and TF140, products of Toda Kogyo Corp.; Beta Random Ultrafine, a product of Ibiden Co. Ltd.; and B-3, a product of Showa Mining Co., Ltd. These abrasives can be also added to a nonmagnetic layer, if needed. By adding abrasives to the nonmagnetic layer, the surface profiling can be controlled, or protuberances of abrasives from the surface can be controlled. Needless to say, optimum values are selected for the particle sizes and the amounts of abrasives added individually to the magnetic layer and the nonmagnetic layer.

Known organic solvents can also be used in the invention. Specifically, they include ketones, such as acetone, methyl ethyl ketone, methyl isobutyl ketone, diisobutyl ketone, cyclohexanone, isophorone and tetrahydrofuran; alcohol compounds, such as methanol, ethanol, propanol, butanol, isobutyl alcohol, isopropyl alcohol and methylcyclohexanol; esters, such as methyl acetate, butyl acetate, isobutyl acetate, isopropyl acetate, ethyl lactate and glycol acetate; glycol ethers, such as glycol dimethyl ether, glycol monoethyl ether and dioxane; aromatic hydrocarbons, such as benzene, toluene, xylene, cresol and chlorobenzene; chlorinated hydrocarbons, such as methylene chloride, ethylene chloride, carbon tetrachloride, chloroform, ethylene chlorohydrin and dichlorobenzene; N,N-dimethylformamide; and hexane, and the invention can use them in arbitrary proportions.

Those organic solvents are not necessarily required to be 100% pure, but they may contain impurities, such as isomers, unreacted materials, by-products, decomposed matter, oxidized matter and moisture, besides their individual main components. The content of these impurities is preferably 30% or less, far preferably 10% or less. The organic solvents used for magnetic and nonmagnetic layers in the invention are preferably identical in kind. The amounts of organic solvent added may differ between the magnetic layer and the nonmagnetic layer. In order to enhance the coating stability, solvents having high surface tension (e.g., cyclohexanone, dioxane) are used in the nonmagnetic layer. More specifically, it is essential that the arithmetic mean of the solvent composition for the upper layer be not less than the arithmetic mean of the solvent composition for the nonmagnetic layer. In order to promote the dispersibility, it is advantageous to use solvents having rather high polarity, and besides, it is preferable that solvents having dielectric constants of 15 or above make up at least 50% of the solvent composition. In addition, it is preferable that the solubility parameter is from 8 to 11.

In the invention, if needed, it is possible to change the kinds and usages of dispersants, lubricants and surfactants as recited above so as to suit the magnetic layer and a nonmagnetic layer described hereinafter, respectively. Needless to say, how to change should not be confined to the cases shown below. For instance, since the dispersants produce adsorbing or bonding action by their polar groups, it is supposed that the polar groups are adsorbed or bonded mainly to the surface of ferromagnetic metal powder in the magnetic layer, while they are adsorbed or bonded mainly to the surface of nonmagnetic powder in the nonmagnetic layer, and more specifically, organic phosphorus compounds once adsorbed, for example, resist desorption from the metal and metallic compound surfaces. In the invention, therefore, the ferromagnetic metal powder surface and the nonmagnetic powder surface are brought to a state in which they are covered with alkyl groups or/and aromatic groups. As a result, the ferromagnetic metal powder and the nonmagnetic powder obtain improvements in affinity for binder constituents, and their dispersion stabilities are also enhanced. As for lubricants, since they are present in a free state, it can be thought that their exudation to the surface is controlled by using, e.g., fatty acids different in melting point or esters different in boiling point or polarity in the nonmagnetic layer and the magnetic layer, respectively, their coating stability is increased through adjustment to the amount of surfactants added, and their lubrication effect is enhanced by making the addition amount of lubricants larger in the nonmagnetic layer than in the magnetic layer. Further, all or part of the additives used in the invention may be added in any step of preparation process of a coating composition for the magnetic layer or the nonmagnetic layer. For instance, there may be cases where additives are mixed with ferromagnetic powder before a kneading step, they are added in the step of kneading ferromagnetic powder with a binder and a solvent, they are added during or after the dispersing step, and they are added just before applying a coating composition.

<Nonmagnetic Layer>

Details on a nonmagnetic layer are described below. The magnetic recording medium of the invention can have on a nonmagnetic support a nonmagnetic layer containing nonmagnetic powder and a binder. The nonmagnetic powder used in the nonmagnetic layer may be either an inorganic substance, or an organic substance. In addition, carbon black can be used therein. Examples of an inorganic substance usable as the nonmagnetic powder include metals, metallic oxides, metallic carbonates, metallic sulfates, metallic nitrides, metallic carbides and metallic sulfides.

More specifically, titanium oxides including titanium dioxide, cerium oxide, tin oxide, tungsten oxide, ZnO, ZrO₂, SiO₂, Cr₂O₃, α-alumina having an α-alumina content of 90 to 100%, α-alumina, γ-alumina, alpha iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide and titanium carbide can be used alone or as combinations of two or more thereof. Of these inorganic substances, alpha iron oxide and titanium oxides are preferred over the others.

The shapes of those nonmagnetic powders may be any of acicular, spherical, polyhedral and tabular shapes. The crystallite sizes of nonmagnetic powders are preferably from 4 nm to 500 nm, far preferably from 40 nm to 100 nm. So long as their crystallite sizes are in the range of 4 to 500 nm, the nonmagnetic powders can be dispersed without difficulty, and can contribute to suitable surface roughness. Although the average particle diameter of those nonmagnetic powders is preferably from 5 nm to 500 nm, this range may be attained, if required, by combined use of nonmagnetic powders differing in average particle diameter, or by solo use of nonmagnetic powder having a broad distribution with respect to particle diameters. The especially favorable average particle diameter of nonmagnetic powder is from 10 nm to 200 nm. So long as its average particle diameter is from 5 to 500 nm, the nonmagnetic powder can favorably attain a well-dispersed state and ensure suitable surface roughness.

The specific surface area of nonmagnetic powder is from 1 to 150 m²/g, preferably from 20 to 120 m²/g, far preferably from 50 to 100 m²/g. So long as its specific surface area is in the range of 1 to 150 m²/g, the nonmagnetic powder has an advantage in its suitability for ensuring appropriate surface roughness and being dispersed with a desired amount of binder. The oil absorption as measured by use of dibutyl phthalate (DBP) is from 5 to 100 ml/100 g, preferably from 10 to 80 ml/100 g, far preferably from 20 to 60 ml/100 g. The specific gravity is from 1 to 12, preferably from 3 to 6. The tap density is from 0.05 to 2 g/ml, preferably from 0.2 to 1.5 g/ml. So long as its tap density is in the range of 0.05 to 2 g/ml, the nonmagnetic powder is easy to handle because scatter of its particles is relatively little, and further tends to resist sticking to apparatus. The pH of nonmagnetic powder is preferably from 2 to 11, particularly preferably between 6 and 9. So far as the pH is from 2 to 11, no increase in friction coefficient is caused under high temperature and high humidity or due to liberation of fatty acids. The moisture content in nonmagnetic powder is from 0.1 to 5 mass %, preferably from 0.2 to 3 mass %, far preferably from 0.3 to 1.5 mass %. So long as the moisture content is in the range of 0.1 to 5 mass %, the dispersion of nonmagnetic powder is in a good condition, and the viscosity of the coating composition after dispersion is favorably stabilized. The loss on ignition is preferably 20 mass % or less, and the lower the loss on ignition, the more suitable the nonmagnetic powder becomes for use in the invention.

When the nonmagnetic powder is an inorganic powder, the Mohs' hardness thereof is preferably from 4 to 10. So long as its Mohs' hardness is in the range of 4 to 10, it can ensure durability. The stearic-acid adsorption amount of the nonmagnetic powder is from 1 to 20 μmol/m², preferably from 2 to 15 μmol/m². Further, it is advantageous for the nonmagnetic powder to have heat of wetting with water at 25° C. in the range of 200 to 600 erg/cm² (200 to 600 mJ/m²). When the heat of wetting with a solvent is within such a range, the solvent can also be used. It is appropriate that 1 to 10 water molecules be present per 100 Å on the nonmagnetic powder surface at 100 to 400° C. The pH of nonmagnetic powder at the isoelectric point in water is preferably between 3 to 9. Moreover, it is appropriate that any of Al₂O₃, SiO₂, TiO₂, ZrO₂, SnO₂, Sb₂O₃ and ZnO be present on the surface of nonmagnetic powder by surface treatment. Of these oxides, Al₂O₃, SiO₂, TiO₂ and ZrO₂, especially Al₂O₃, SiO₂ and ZrO₂, are preferred over the others from the viewpoint of dispersibility. Those oxides may be used alone or in combination. Additionally, they may be used in the form of a layer surface-treated by coprecipitation according to the desired purposes, or surface treatment may be performed by adopting a method in which the surface of nonmagnetic powder is treated with alumina first, and then the surface layer thus formed is treated with silica, or the method in which the treating order is reversed. Alternatively, the surface-treated layer may be a porous layer as required, but a homogeneous and dense layer is generally preferred.

Examples of commercially available nonmagnetic powders usable in the nonmagnetic layer according to the invention include Nanotite, a product of Showa Denko K.K.; HIT-100 and ZA-GI, products of Sumitomo Chemical Co., Ltd.; DPN-250, DPN-250BX, DPN-245, DPN-270BX, DPB-55-BX and DPN-550Rx, products of Toda Kogyo Corp.; Titanium Oxides TTO-51B, TTO-55A, TTO-55B, TTO-55C, TTO-55S, TTO-55D, SN-100 and MJ-7, Alpha Iron Oxides E270, E271 and D300, products of Ishihara Sangyo Kaisha Ltd.; STT-4D, STT-30D, STT-30 and STT-65C, products of Titan Kogyo Kabushiki Kaisha; and MT-100S, MT-100T, MT-150W, MT-500B, T-600B, T-100F and T-500HD, products of Tayca Corporation. In addition, FINEX-25, BF-1, BF-10, BF-20 and ST-M, products of Sakai chemical Industry Co., Ltd.; DEFIC-Y and DEFIC-R, products of Dowa Holdings Co., Ltd.; AS2BM and TiO2P25, products of Nippon Aerosil Co., Ltd.; 100A and 500A, products of Ube Industries, Ltd.; Y-LOP, a product of Titan Kogyo Kabushiki Kaisha; and burned materials of these products can also be used. Of these nonmagnetic powders, titanium dioxide and alpha iron oxide are especially preferred.

Together with nonmagnetic powers, carbon black can be mixed in the nonmagnetic layer, and thereby not only the surface electrical resistance and light transmittance can be reduced, but also the desired Vickers microhardness can be attained. The suitable Vickers microhardness of the nonmagnetic layer is generally from 25 to 60 kg/mm² (245 to 588 MPa), favorably from 30 to 50 kg/mm² (294 to 490 MPa) for adjustment to a hit by a head, and such hardness can be measured with a thin-film hardness tester (Model HMA-400, made by NEC Corporation) utilizing as an indenter tip a diamond triangular pyramid stylus having an edge angle of 80 degrees and a tip radius of 0.1 μm. For details of such measurement a book, e.g., Usumaku no Rikigakuteki Tokusei Hyoka Gijutsu (which might be literally translated “Techniques for Evaluating Mechanical Characteristics of Thin Films”), published by Realize Corporation, can be referred to. The light transmission is generally standardized at 3% or less in terms of absorption of infrared rays with wavelengths around 900 nm, and more specifically, 0.8% or less in the case of VHS-format magnetic tape. In order to meet such a requirement, it is possible to utilize furnace black for rubber use, thermal black for rubber use, carbon black for color use and acetylene black.

The specific surface area of carbon black used for the nonmagnetic layer in the invention is from 100 to 500 m²/g, preferably from 150 to 400 m²/g, and the DBP oil absorption of the carbon black is from 20 to 400 ml/100 g, preferably from 30 to 200 ml/100 g. The particle diameter of the carbon black is from 5 to 80 nm, preferably from 10 to 50 nm, far preferably from 10 to 40 nm. The pH of the carbon black is preferably from 2 to 10, the moisture content is preferably from 0.1 to 10%, and the tap density is preferably from 0.1 to 1 g/ml.

Concrete examples of carbon black which can be used for the nonmagnetic layer in the invention include BLACKPEARLS 2000, 1300, 1000, 900, 800, 880 and 700, and VULCAN XC-72, which are products of Cabot Co.; #3050B, #3150B, #3250B, #3750B, #3950B, #950, #650B, #970B, #850B and MA-600, which are products of Mitsubishi Chemical Industries Ltd.; CONDUCTEX SC, and RAVEN 8800, 8000, 7000, 5750, 5250, 3500, 2100, 2000, 1800, 1500, 1255 and 1250, which are products of Colombia Carbon Co.; and KETJENBLACK EC produced by Ketjen Black International Company.

Carbon black surface-treated with a dispersant, carbon black onto which a resin is grafted, or carbon black whose surface is partly converted into graphite may be used. Alternatively, carbon black may be dispersed into a binder before it is added to a magnetic coating composition. The carbon black as recited above can be used in an amount no larger than 50 mass % based on the inorganic powder and no larger than 40 mass % based on the total ingredients in the nonmagnetic layer. Those carbon black products can be used alone or in combination. Details of carbon black usable in the nonmagnetic layer according to the invention can refer to, e.g., Carbon Black Binran (Handbook on Carbon Black), compiled by Carbon Black Association.

Organic powder can also be added to the nonmagnetic layer in response to the end-use purpose. Examples of such organic powder include acrylic-styrene resin powder, benzoguanamine resin powder, melamine powder, and phthalocyanine pigment. In addition, polyolefin resin powder, polyester resin powder, polyamide resin powder, polyimide resin powder and polyfluoroethylene resin powder can also be used. To manufacturing these powders, the methods as disclosed in JP-A-62-18564 and JP-A-60-255827 can be applied.

To bindera, lubricants, dispersants, additives, solvents and dispersion methods used for the nonmagnetic layer, those used for the magnetic layer can be applied. Known techniques for the magnetic layer are applicable especially to the kinds and usage of binders, additives, and the kinds and usage of dispersants.

Further, the magnetic recording medium of the invention may be provided with a subbing layer. The subbing layer provided can enhance adhesion force between the support and the magnetic layer or the nonmagnetic layer. For the subbing layer, polyester resins soluble in solvents can be used.

<Layer Structure>

Where the thickness design usable for the present magnetic recording medium is concerned, the thickness of a nonmagnetic support is from 3 to 80 μm as is described above, and it is preferably from 3 to 50 μm, far preferably from 3 to 10 μm. When a subbing layer is provided between the nonmagnetic support and a nonmagnetic layer or a magnetic layer, the subbing layer thickness is adjusted to a range of 0.01 to 0.8 μm, preferably 0.02 to 0.6 μm.

The subbing layer (smoothening layer) can be formed by coating the surface of the nonmagnetic support with a coating solution containing a polymer and drying the coated solution, or by coating the surface of the nonmagnetic support with a coating solution containing a compound having a radiation-curable functional group in its molecule (a radiation-curable compound) and then curing the coating solution by application of radiation.

The molecular weight of a radiation-curable compound is preferably in a range of 200 to 2,000. The molecular weights in such a range are relatively low, so it is easy for the coating formed to show flowability in a calendering process and the moldability of the coating is high. Accordingly, such a compound makes it possible to form a smooth coating.

Compounds suitable as the radiation-curable compounds are bifunctional acrylate compounds having their molecular weights in the range of 200 to 2,000, and more suitable ones include bisphenol A, bisphenol F, hydrogenated bisphenol A, hydrogenated bisphenol F, and compounds prepared by addition of acrylic acid or methacrylic acid to alkylene oxide adducts of those bisphenol compounds.

When they are used in the invention, the radiation-curable compounds may be used in combination with a binder of polymer type. Examples of such a binder include hitherto known thermoplastic resins, thermosetting resins, reactive resins and mixtures of these resins. When UV rays are used as the radiation, it is preferable that the radiation-curable compounds are used in combination with polymerization initiators. As the polymerization initiators, known radical photopolymerization initiators, cationic photopolymerization initiators and photo-amine generators can be used.

In addition, radiation-curable compounds can also be used in a nonmagnetic layer.

The thickness of the magnetic layer is optimized according to the saturation magnetization and the head gap length of a magnetic head used and the frequency band of recording signals. The variation (σ/δ) in thickness of the magnetic layer is preferably 20% or less, far preferably 15% or less. Although the presence of at least one magnetic layer is good enough, there is nothing wrong with separating the magnetic layer into two or more layers differing in magnetic characteristics, and known structures concerning multiple magnetic layers can be applied to such cases.

The thickness of the nonmagnetic layer in the invention is from 0.1 to 3.0 μm, preferably from 0.3 to 2.0 μm, far preferably from 0.5 to 1.5 μm. Incidentally, the nonmagnetic layer of the present magnetic recording medium can achieve its effect so long as it is nonmagnetic in a substantial sense. For instance, the effects of the invention are produced even when magnetic impurities are contained or minor amounts of magnetic substances are intentionally incorporated in the nonmagnetic layer, so such cases can also be considered to be structurally identical in a substantial sense to the present magnetic recording medium. The expression “identical in a substantial sense” as used herein means that the nonmagnetic layer is 10 mT or less in residual flux density or 7.96 kA/m (10 Oe) or less in coercive force, and preferably it has neither residual flux density nor coercive force.

<Backing Layer>

The present magnetic recording medium is preferably provided with a backing layer on the other side of the nonmagnetic support. It is advantageous for the backing layer to contain carbon black and inorganic powder. To a binder and various additives for the backing layer, formulae for the magnetic layer and the nonmagnetic layer can be applied. The thickness of the backing layer is preferably 0.9 μm or less, far preferably 0.1 to 0.7 μm.

<Manufacturing Method>

The process of preparing a coating composition used for the magnetic layer, the nonmagnetic layer or the backing layer in the invention includes at least a kneading step, a dispersing step, and mixing steps provided before or after those steps as required. Each step may be separated into at least two stages. Each of ingredients used in the invention, such as ferromagnetic powder, a binder, carbon black, an abrasive, an antistatic agent, a lubricant and a solvent, may be added at the beginning or in the course of any step. In addition, each ingredient may be divided into two or more portions and added in separate steps. For instance, the input of polyurethane resin may be divided among a kneading step, a dispersing step and a mixing step for viscosity adjustment after dispersion. In order to achieve the object of the invention, the preparation techniques hitherto known can be applied to some steps. In the kneading step, it is advantageous to use a mighty kneading machine, such as an open kneader, a continuous kneader, a pressurized kneader or an extruder. The details of kneading processing are described in JP-A-1-106338 and JP-A-1-79274. At the dispersing step in preparation of coating compositions for the magnetic layer, the nonmagnetic layer or the backing layer, glass beads can be used. As these glass beads, a dispersion medium of high gravity, such as zirconia beads, titania beads or steel beads, is suitable. In using such a dispersion medium, its particle size and packing rate are optimized. For dispersion, known dispersing machine can be used.

In the method of manufacturing the present magnetic recording medium, a coating composition for magnetic-layer use is applied to the surface of a nonmagnetic support under running so that the magnetic layer formed has the intended thickness. Herein, two or more coating compositions for magnetic-layer use may be applied sequentially or simultaneously, and thereby multiple layers may be coated. On the other hand, a coating composition for magnetic-layer use and a coating composition for nonmagnetic-layer use may be applied sequentially or simultaneously, thereby forming double layers. As a coating machine for applying the coating composition for magnetic-layer or nonmagnetic-layer use, an air doctor coater, a blade coater, a rod coater, an extrusion coater, an air knife coater, a squeegee coater, an impregnation coater, a reverse roll coater, a transfer roll coater, a gravure coater, a kiss coater, a cast coater, a spray coater or a spin coater can be utilized. For details of these coaters Saishin Coating Gijutsu (which might be literally translated “Newest Coating Technology”), published by K.K. Sogo Gijutsu Center (May 31, 1983), can be referred to.

In the case of magnetic tape, ferromagnetic powder in the coating layer of a coating composition for magnetic-layer use may undergo magnetic alignment treatment using a cobalt magnet or a solenoid. In the case of a disk, though the disk can sometimes have sufficiently isotropic orientation even when no orientation apparatus is used, so the powder is not forced to orient, the use of a known random orientation apparatus, such as cobalt magnets configured in a staggered form or a solenoid for application of an alternating magnetic field, is preferable. In the case of ferromagnetic metal powder, the suitable isotropic orientation is generally in-plane two-dimensional random orientation, but it is possible to add a vertical component, thereby creating three-dimensional random orientation. On the other hand, a magnetic property isotropic in the circumferential direction can be imparted by performing vertical orientation using a known method, e.g., opposite polarity-faced magnets. In the case of carrying out high-density recording in particular, vertical orientation is preferred. Moreover, circumferential orientation may be provided by spin coating.

It is preferable that the drying position on the coating layer is controlled by properly adjusting the temperature and volume of drying air and the coating speed. Specifically, the coating speed may be chosen from the range of 20 to 1,000 m/min, and the suitable temperature of drying air is 60° C. or above. In addition, the coating layer may undergo appropriate pre-drying treatment before it enters into the magnet zone.

The thus obtained coating web is once wound onto a take-up roll, and then wound off from the take-up roll and subjected to calendering treatment.

In calendering treatment, a supercalender roll can be utilized. By the calendering treatment, not only surface smoothness is enhanced, but also the packing density of ferromagnetic powder in the magnetic layer is increased because holes formed by removal of the solvent at the time of drying disappear. So the magnetic recording medium high in electromagnetic conversion characteristics can be obtained. It is preferable that the calendering step is performed while changing the calendering condition according to the surface smoothness of the coated web.

The coated web generally decreases in glossiness from the core side of the take-up roll toward the outside, and the quality thereof sometimes exhibits variations in the length direction. Additionally, it is known that the glossiness is in correlation (proportional relationship) with the surface roughness Ra. Therefore, the maintenance of consistency in calendering conditions, e.g., calender-roll pressure, during the calendering process means that no measure is taken against smoothness discrepancies in the length direction due to winding of the coated web onto a take-up roll, so quality variations occur in the length direction of the final product.

Accordingly, it is appropriate that adjustments to calendering conditions, e.g., calender roll pressure, during the calendering process be made so as to compensate for the smoothness discrepancies in the length direction due ton the winding of the coated web onto a take-up roll. More specifically, it is preferable that the calender roll pressure is gradually decreased toward the core side of the coated web which is being wound off from the take-up roll. From our study, occurrence of a decrease in glossiness (smoothness) with decreasing calender roll pressure has been found. By such adjustments of calender roll pressure, the smoothness discrepancies in the length direction due to winding of coated web onto a take-up roll can be compensated, final products free of quality variations in the length direction can be obtained.

Besides the above case in which the calender roll pressure is varied, discrepancies in the smoothness can be compensated by controlling the temperature, speed or tension of a calender roll used. All characteristics of a recording medium formed by coating operations considered, it is appropriate that the calender roll pressure or temperature be controlled. The surface smoothness of the final product is reduced by lowering the calender roll pressure or temperature. Conversely, the surface smoothness of the final product is enhanced by raising the calender roll pressure or temperature.

Aside from the foregoing, the magnetic recording medium obtained after the calendering step can also undergo thermal treatment, and thereby the thermosetting thereof can make progress. The thermal treatment temperature, though may be chosen appropriately according to the preparation formula of a coating composition for the magnetic layer, is roughly from 35 to 100° C., preferably from 50 to 80° C. In addition, the thermal treatment time is from 12 to 72 hours, preferably from 24 to 48 hours.

Examples of a calender roll usable in the invention include heat-resistant plastic rolls, such as an epoxy resin roll, a polyimide resin roll, a polyamide resin roll and a polyamide imide resin roll. Alternatively, the calendering may be performed with a metallic roll.

As mentioned above, the surface of the present magnetic recording medium is preferably an extremely smooth surface. As for the calendering conditions suitable for achieving such surface smoothness, the calender roll temperature is from 60 to 100° C., preferably from 70 to 100° C., particularly preferably from 80 to 100° C., and the pressure is from 100 to 500 kg/cm (98 to 490 kN/m), preferably from 200 to 450 kg/cm (196 to 441 kN/m), particularly preferably from 300 to 400 kg/cm (294 to 392 kN/m).

The magnetic recording medium obtained can be used in a state of being cut into desired sizes by means of a cutting machine. The cutting machine has no particularly restriction, but a cutting machine equipped with more than one set of a rotating upper blade (a male blade) and a rotating lower blade (a female blade) is used to advantage, and the slitting speed thereof, the mesh depth thereof, the peripheral speed ratio between the upper blade (male blade) and the lower blade (female blade) (upper-blade peripheral speed/lower-blade peripheral speed) and the continuous use time of slitting blades are chosen as appropriate, respectively.

<Physical Property>

The saturation flux density of the magnetic layer of the magnetic recording medium used in the invention is preferably from 100 to 400 mT. The coercive force (Hc) of the magnetic layer is preferably from 143.2 to 318.3 kA/m (1,800 to 4,000 Oe), far preferably from 159.2 to 278.5 kA/m (2,000 to 3,500 Oe). The narrower distribution of coercive forces is preferable, and SFD and SFDr are each 0.6 or less, preferably 0.3 or less.

The coefficient of friction of the present magnetic recording medium against a head used in the invention is 0.50 or less, preferably 0.3 or less, as measured at temperatures ranging from −10 to 40° C. and humidities ranging 0 to 95%. The surface resistivity is preferably from 10⁴ to 10⁸ Ω/sq as measured on the magnetic surface, and electrification potential is preferably within the range of −500V to +500V. The elasticity modulus of the magnetic layer under an elongation of 0.5% is preferably from 0.98 to 19.6 GPa (100 to 2,000 kg/mm²) in all in-plane directions, the tensile strength at break is preferably from 98 to 686 MPa (10 to 70 kg/mm²), the elasticity modulus of the magnetic recording medium is preferably from 0.98 to 14.7 GPa (100 to 1,500 kg/mm²) in all in-plane directions, the residual elongation is preferably 0.5% or less, and the percentage of thermal shrinkage at every temperature no higher than 100° C. is preferably 1% or less, far preferably 0.5% or less, especially preferably 0.1% or less.

The glass transition temperature of the magnetic layer (the maximum of tangent in dynamic viscoelasticity measurements made at 110 Hz by dynamic viscoelasticity measuring apparatus, RHEOVIBRON, or the like) is from 50 to 180° C., and that of the non-magnetic layer is preferably from 0 to 180° C. The loss elasticity modulus is preferably in the range of 1×10⁷ to 8×10⁸ Pa (1×10⁸ to 8×10⁹ dyne/cm²), and the loss tangent is preferably 0.2 or less. When the loss tangent is too great, blocking troubles tend to occur. It is preferable that these thermal and mechanical characteristics in every in-plane direction of the medium are equal within tolerance of 10%.

The residual solvent in the magnetic layer is preferably 100 mg/m² or less, far preferably 10 mg/m². The porosity that each of coating layers, namely the nonmagnetic and magnetic layers, has is preferably 40% by volume or less, far preferably 30% by volume or less. Although the smaller porosity is more favorable for attainment of high output, there may be cases where it is better to secure a measure of porosity, depending on the intended purposes. In point of running durability, for instance, it is often advantageous for repeatability-oriented disk media to have some porosity.

The ten-point average roughness (Rz) of the magnetic layer is preferable 30 nm or less. This can be easily controlled by controlling the surface properties of the support with fillers or controlled according to the surface profiling of the roll in the calendering treatment. Curl is preferably controlled within ±3 mm.

The present magnetic recording medium can vary these physical properties between the magnetic layer and the nonmagnetic layer according to the intended purposes. For instance, the running durability can be enhanced by heightening the elasticity modulus of the magnetic layer, and at the same time, a head can hit well against the magnetic recording medium by the elasticity modulus of the nonmagnetic layer being adjusted to a lower setting than that of the magnetic layer.

As a playback method applicable to the present magnetic recording medium, playback of signals magnetically recorded at a maximum linear recording density of 200 KFCI or above by use of an AMR head, preferably a GMR head, is suitable.

The between-shield (sh-sh) distance is, e.g., from 0.08 μm to 0.18 μm, and the playback track width is, e.g., from 0.5 μm to 3.5 μm.

When the present magnetic recording medium is a magnetic recording medium in tape form, the use of a GMR head as the playback head enables playback with a high S/N ratio even in the case of signals recorded in a higher frequency region than usual. Therefore, the present magnetic recording medium is best suitable as computer data-recording magnetic tape and disk-form magnetic recording medium for higher-density recording.

### EXAMPLES

The invention will now be illustrated in more detail by reference to the following examples, but these examples should not be construed as limiting the scope of the invention.

Additionally, all parts in the following examples are by mass unless otherwise indicated.

### Example 1

<Ingredients of Upper-Layer Magnetic Coating Composition>

| | | |
|---|---|---|
| Hexagonal barium ferrite powder | 100 | parts |
| Hc: 2,000 Oe (160 kA/m), Average tabular diameter: | | |
| 20 nm, Average tabular ratio: 3, BET specific surface | | |
| area: 80 m²/g, σs: 50 emu/g (50 Am²/kg) | | |
| Polyurethane resin containing sulfo groups | 18 | parts |
| Diamond powder (average particle size: 50 nm) | 1 | parts |
| Silicon carbide powder (average particle size: 30 nm) | 1 | parts |
| Cyclohexanone | 150 | parts |
| Methyl ethyl ketone | 150 | parts |
| Toluene | 100 | parts |
| Butyl stearate | 2 | parts |
| Stearic acid | 1 | parts |

<Ingredients of Coating Composition for Nonmagnetic Layer>

| | | |
|---|---|---|
| Iron oxide powder (average long-axis length: 80 nm) | 80 | parts |
| Carbon black (average particle size: 25 nm) | 20 | parts |
| Vinyl chloride copolymer resin | 10 | parts |
| Polyurethane resin containing sulfo groups | 5 | parts |
| Phenylphosphonic acid | 2 | parts |
| Cyclohexanone | 130 | parts |
| Methyl ethyl ketone | 100 | parts |
| Butyl stearate | 1 | parts |
| Stearic acid | 1.5 | parts |

<Preparation of Subbing-Layer Coating Composition>

The following ingredients were mixed with stirring to prepare a coating composition for a subbing layer.

| | |
|---|---|
| Dimethyloltricyclodecane diacrylate | 100 parts |
| Methyl ethyl ketone | 100 parts |

The ingredients to constitute each of the foregoing upper-layer magnetic coating composition and lower-layer nonmagnetic coating composition were kneaded for 60 minutes with an open kneader, and then dispersed for 600 minutes by use of a sand mill. To each of the thus obtained dispersions, 6 parts of trifunctional low-molecular polyisocyanate compound (Coronate 3041, a product of Nippon Polyurethane Industry Co., Ltd.) was added, and mixed for 20 minutes with stirring. Thereafter, each of the resulting mixtures was passed through a filter having an average pore size of 1 μm. Thus, the upper-layer magnetic coating composition and the lower-layer nonmagnetic coating composition were prepared. To a 5 μm-thick PEN support having surface roughness Ra of 1.4 nm on the magnetic layer-forming side and 2.0 nm on the backing layer-forming side, the lower-layer nonmagnetic coating composition was applied so as to have a thickness of 1.5 μm after drying, dried at 100° C., and then wound into a roll, thereby making a lower-layer coated web. The thus made web was subjected to mirror-finish treatment using a 7-stage calender (temperature: 100° C., linear pressure: 300 kg/cm (294 kN/m), treatment speed: 50 m/min), and further to 36 hours' thermal treatment at 70° C. To the thus treated lower-layer coated web, the subbing-layer coating composition was applied so as to have a thickness of 0.5 μm after drying, dried at 100° C., and then irradiated with electron beams in a dose of 5 Mrad under an acceleration voltage of 100 kV. To the thus irradiated coating composition, the upper-layer magnetic coating composition was applied in accordance with a wet-on-dry method so as to have a thickness of 100 nm after drying, and then dried at 100° C.

Next, a coating composition for a backing layer was applied to the other side of the nonmagnetic support, which was opposite to the side on which the nonmagnetic lower layer and the magnetic layer were formed, so that the backing layer formed had a thickness of 0.5 μm after drying and subsequent calendering, and then dried. The coating composition used for backing layer formation was prepared as follows: The ingredients described below were dispersed by using a beads mill at a residence time setting of 45 minutes, and thereto 8.5 parts of polyisocyanate was added, stirred and then filtered.

<Ingredients of Coating Composition for Backing Layer>

| | | |
|---|---|---|
| Carbon black (average particle size: 25 nm) | 40.5 | parts |
| Carbon black (average particle size: 370 nm) | 0.5 | parts |
| Barium sulfate | 4.05 | parts |
| Nitrocellulose | 28 | parts |
| Polyurethane resin (containing SO₃Na groups) | 20 | parts |
| Cyclohexanone | 100 | parts |
| Toluene | 100 | parts |
| Methyl ethyl ketone | 100 | parts |

The thus obtained magnetic sheet was subjected to mirror-finish treatment with a 7-stage calender (temperature: 100° C., linear pressure: 300 kg/cm (294 kN/m), treatment speed: 80 m/min), and further to 48 hours' thermal treatment at 70° C. Thereafter, the thus treated magnetic sheet was slit into ½-inch-wide strips, thereby forming magnetic tapes.

### Example 2

The coating composition used for the nonmagnetic lower layer in Example 1 was changed to the following. Specifically, the ingredients described below were kneaded for 60 minutes with an open kneader, and then dispersed for 600 minutes by use of a sand mill. The dispersion thus obtained was passed through a filter having an average pore size of 1 μm, thereby preparing a nonmagnetic lower-layer coating composition for Example 2. The thus prepared nonmagnetic lower-layer coating composition was applied to a 5 μm-thick PEN support having surface roughness Ra of 1.4 nm on the magnetic layer-forming side and 2.0 nm on the backing layer-forming side so as to have a thickness of 1.5 μm after drying, dried at 100° C., and then wound into a roll, thereby making a lower layer-coated web. The thus made web was subjected to mirror-finish treatment using a 7-stage calender (temperature: 100° C., linear pressure: 300 kg/cm (294 kN/m), treatment speed: 50 m/min), and further irradiated with electron beams in a dose of 5 Mrad under an acceleration voltage of 100 kV. To the resulting lower-layer coated web, the subbing-layer coating composition was applied so as to have a thickness of 0.5 μm after drying, dried at 100° C., and then irradiated with electron beams in a dose of 5 Mrad under an acceleration voltage of 100 kV. To the thus irradiated coating composition, the magnetic coating composition was applied in accordance with a wet-on-dry method so as to have a thickness of 50 nm after drying, and then dried at 100° C. In the process thereafter, the same method as in Example 1 was adopted, thereby making magnetic tapes of Example 2.

<Ingredients of Nonmagnetic Lower-layer Coating Composition>

| | | |
|---|---|---|
| Iron oxide powder (average long-axis length: 80 nm) | 80 | parts |
| Carbon black (average particle size) | 20 | parts |
| Electron beam-curable vinyl chloride copolymer resin | 10 | parts |
| Electron beam-curable polyurethane resin | 5 | parts |
| Phenylphosphonic acid | 2 | parts |
| Methyl ethyl ketone | 130 | parts |
| Cyclohexanone | 130 | parts |
| Stearic acid | 1 | parts |
| Butyl stearate | 1.5 | parts |

### Example 3

To a 5 μm-thick PEN support having surface roughness Ra of 1.4 nm on the magnetic layer-forming side and 2.0 nm on the backing layer-forming side, the same subbing-layer coating composition as used in Example 1 was applied so as to have a thickness of 0.5 μm after drying, dried at 100° C., and then irradiated with electron beams in a dose of 5 Mrad under an acceleration voltage of 100 kV To the thus irradiated coating composition, the magnetic coating composition was applied in accordance with a wet-on-dry method so as to have a thickness of 30 nm after drying, and then dried at 100° C.

In the process thereafter, the same method as in Example 1 was adopted, thereby making magnetic tapes of Example 3.

### Example 4

To a 5 μm-thick PEN support having surface roughness Ra of 1.4 nm on the magnetic layer-forming side and 2.0 nm on the backing layer-forming side, the same upper-layer magnetic coating composition as used in Example 1 was applied so as to have a thickness of 80 nm after drying, and then dried at 100° C.

In the process thereafter, the same method as in Example 1 was adopted, thereby making magnetic tapes of Example 4.

### Comparative Example 1

To a 5 μm-thick PEN support having surface roughness Ra of 1.4 nm on the magnetic layer-forming side and 2.0 nm on the backing layer-forming side, the same nonmagnetic lower-layer coating composition as used in Example 1 was applied so as to have a thickness of 1.5 μm after drying, dried at 100° C., and then wound into a roll, thereby making a lower-layer coated web. Then, the lower-layer coated web was subjected to 36 hours' thermal treatment at 70° C. To the thus treated lower-layer coated web, the upper-layer magnetic coating composition was applied in accordance with a wet-on-dry method so as to have a thickness of 100 nm after drying, and then dried at 100° C. In the process thereafter, the same method as in Example 1 was adopted, thereby making magnetic tapes of Comparative Example 1.

### Comparative Example 2

To a 5 μm-thick PEN support having surface roughness Ra of 1.4 nm on the magnetic layer-forming side and 2.0 nm on the backing layer-forming side, the same nonmagnetic lower-layer coating composition as used in Example 1 was applied so as to have a thickness of 1.5 μm after drying, dried at 100° C., and then wound into a roll, thereby making a lower-layer coated web. Then, the lower-layer coated web was subjected to 36 hours' thermal treatment at 70° C. To the thus treated lower-layer coated web, the upper-layer magnetic coating composition was applied in accordance with a wet-on-dry method so as to have a thickness of 150 nm after drying, and then dried at 100° C. In the process thereafter, the same method as in Example 1 was adopted, thereby making magnetic tapes of Comparative Example 2.

### Comparative Example 3

To a 5 μm-thick PEN support having surface roughness Ra of 1.4 nm on the magnetic layer-forming side and 2.0 nm on the backing layer-forming side, the same lower-layer nonmagnetic coating composition as used in Example 1 was applied so that a coating formed had a thickness of 1.5 μm after drying. To this coating, the magnetic coating composition was applied in accordance with a wet-on-wet method so as to have a thickness of 100 nm after drying, and then dried at 100° C. In the process thereafter, the same method as in Example 1 was adopted, thereby making magnetic tapes of Comparative Example 3.

### Comparative Example 4

To a 5 μm-thick PEN support having surface roughness Ra of 1.4 nm on the magnetic layer-forming side and 2.0 nm on the backing layer-forming side, the same lower-layer nonmagnetic coating composition as used in Example 1 was applied so as to have a thickness of 1.5 μm after drying, dried at 100° C., and then wound into a roll, thereby making a lower-layer coated web. Then, the lower-layer coated web was subjected to mirror-finish treatment using a 7-stage calender (temperature: 100° C., linear pressure: 300 kg/cm (294 kN/m), treatment speed: 50 m/min). To the thus treated lower-layer coated web, the magnetic coating composition was applied in accordance with a wet-on-dry method so as to have a thickness of 50 nm after drying, and then dried at 100° C. In the process thereafter, the same method as in Example 1 was adopted, thereby making magnetic tapes of Comparative Example 4.

### Comparative Example 5

After the same nonmagnetic coating composition as used in Example 1 was applied to a 5 μm-thick PEN support having surface roughness Ra of 1.4 nm on the magnetic layer-forming side and 2.0 nm on the backing layer-forming side so as to form a coating having a dry thickness of 1.5 μm, the magnetic coating composition was applied to the coating in accordance with a wet-on-dry method so as to have a thickness of 30 nm after drying, and then dried at 100° C. In the process thereafter, the same method as in Example 1 was adopted, thereby making magnetic tapes of Comparative Example 5.

The measurements described below were made on the thus obtained samples, and thereby evaluations were performed. Results thereof are shown in Table 1.

<Measurement Method>

(Determination of Average Thickness δ of Magnetic Layer and Standard Deviation a of Magnetic Layer Thickness)

The average thickness δ and standard deviation σ of each magnetic layer thickness were determined under the following procedures (1) and (2):

(1) Acquisition of Magnetic Tape Profile Picture

A cross-sectional ultra-thin slice (slice thickness: about 80 nm to 100 nm) parallel to the length direction of the magnetic tape is cut in accordance with an ultra-microtome method using an embedded block. When an electron micrograph of the magnetic tape profile in the thus cut cross-sectional ultra-thin slice is taken with a transmission electron microscope (TEM H-9000, made by Hitachi Ltd.) of 1.0×10⁵ magnifications, a continuous area extending 25 to 30 μm in the length direction of the magnetic tape and centering on the interface between the magnetic layer and the nonmagnetic layer is photographed, and thereby a continuous profile picture of the magnetic tape is acquired.

(2) From the continuous profile picture thus acquired, the magnetic layer is trimmed by visually drawing lines along the magnetic layer surface and the magnetic layer/nonmagnetic layer interface, respectively. Next the trimmed magnetic layer lines are captured by a scanner, and the space between the magnetic layer surface and the magnetic layer/nonmagnetic layer interface is subjected to image processing, thereby calculating the average thickness δ of the magnetic layer and the standard deviation σ of the magnetic layer thickness. In the image processing, KS Imaging Systems Ver. 3, made by Carl Zeiss, is adopted, and the magnetic layer thickness is measured at about 2,100 points at intervals of 12.5 nm in the length direction of the magnetic layer.

The scale correction at the time of image capture by a scanner and image analysis is made using a line of 2 cm in actual size.

(Determination of Standard Deviation σ_{d} [nm] of Magnetic Substance Distribution in Thickness Direction at Interface)

The standard deviation σ_{d} [nm] of magnetic substance distribution in the thickness direction at the interface was determined under the following procedures (3), (4) and (5):

(3) Acquisition of Depth Profile of Constituent Element of Magnetic Substance in Magnetic Tape

A depth profile of a constituent element of a magnetic substance is measured with a TOF-SIMS system made by ION-TOF GmbH. In the present case, the depth profile of Ba is measured.

Sputtering in the depth direction is performed with an O₂ sputter (2 keV, 125 nA, sputtering area of 225 μm square), and secondary ions (posi) are detected through ionization by Bi ions (25 keV, 1 pA, 10 kHz). The measured area is 50 μm square.

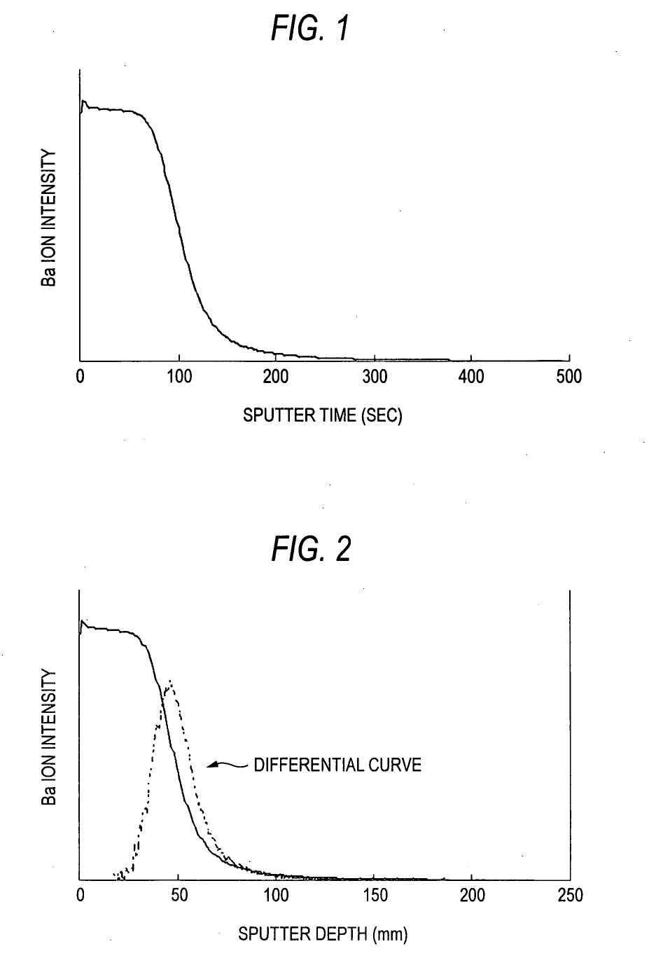

512 cycles of sputtering are performed at intervals of 1.638 seconds. In other words, sputtering is performed long enough till the depth profile curve of a constituent element of the magnetic layer becomes flat (See FIG. 1).

(4) Calculation of Sputter Rate of Magnetic Tape

The lateral axis in the depth profile (FIG. 1) acquired under the foregoing conditions, namely the sputter rate, is calculated from the following equation.

The sputter rate adopted for measurements in the present examples and the comparative examples is 0.47 [nm/sec].
Sputter rate [nm/sec]={sputter depth*(height difference between the sputtered area after depth-profile measurement and the initial surface before sputtering) [nm]/{sputter time [sec]} Equation 1

Herein, the sputter depth is worked out by use of an atomic force microscope “SPA500” made by Seiko Instruments Inc.

The conversions of lateral axis of a depth profile into sputter depth values [nm] are made by multiplying the lateral axis by the sputter rate of 0.47 nm (See FIG. 2).

(5) Calculation of Standard Deviation σ_{d} [nm] of Magnetic Substance Distribution in Thickness Direction at Interface from Depth Profile

The profile extending from minimum to maximum intensity is normalized by drawing a base line of the profile curve (in the flat portion of the intensity profile). The portion corresponding to from 16% to 84% of the maximum intensity taken as 100% is cut from the intensity-decrease profile of a constituent element.

A differential curve of the thus cut intensity-decrease curve is subjected to normal distribution (Gauss' error curve) fitting (approximation), and a standard deviation σ_{d} [nm] of the differential curve is calculated. In the Gauss' error curve approximation, a peak analysis software “Origin-pro. 7.5” is used, and the following Equation 2 is used as the Gauss' error curve.

$$\begin{matrix}Equation 2 \text{:} & \\ y = y 0 + [ A / ( 2 {σ}_{d} \times √ ( π / 2 ) ) ] \times ( exp \{ ( - 2 {( x - x 0 )}^{2} / {( 2 {σ}_{d} )}^{2} ) \} ) & \end{matrix}$$

where
y0=Offset of base line,
A=Total area between curve and base line,
x0=Peak center (average), and
σ_{d}=Standard deviation of magnetic substance distribution in thickness direction at interface.
   (Measurement of Electromagnetic Conversion Characteristic)

Electromagnetic conversion characteristics were determined by use of a drum tester (relative speed: 2 m/sec).

Signals were recorded at a linear recording density of 200 kFCI by use of a write head of Bs=1.6 T and a Gap length of 0.2 μm, and played back with a GMR head (playback track width (Tw): 1.5 μm, sh-sh: 0.16 μm).

SNR was determined by measurement of a ratio between the output at 200 kFCI and the integral of noise from 0 to 400 kFCI. The measurement value in Comparative Example 1 was taken as 0 dB.

The rate of output variation was determined by sampling 2,000 pulses of signals played back from a recording of 33.3 kFCI, calculating a standard deviation from absolute value distribution of the pulse peaks, and defining as a value obtained by dividing the standard deviation by the average value and further multiplying the quotient by 100. When the rate of output variation determined is 15% or less, the output variation is rated as good.

TABLE 1

| | | | Magnetic | | |
|---|---|---|---|---|---|
| | | | powder | | |
| | | | distribution | | |
| | | | in thickness | | |
| | | | direction | | |
| | | | at interface | Electromagnetic | |
| | Magnetic layer | | (TOF- | conversion | |
| | thickness (TEM) | | SIMS) | characteristics | |
| | Average | Standard | Standard | Output | |
| | thickness | deviation | deviation | variation | SNR |
| | δ nm | σ nm | σ_{d} nm | rate % | dB |
| Example 1 | 100 | 18 | 25 | 10 | 2.0 |
| Example 2 | 50 | 8 | 12 | 8 | 2.7 |
| Example 3 | 30 | 6 | 8 | 5 | 3.2 |
| Example 4 | 80 | 10 | 30 | 15 | 1.5 |
| Comparative | 100 | 15 | 52 | 18 | 0 |
| Example 1 | | | | | |
| Comparative | 150 | 18 | 60 | 25 | −1.8 |
| Example 2 | | | | | |
| Comparative | 100 | 30 | 70 | 30 | −3.2 |
| Example 3 | | | | | |
| Comparative | 50 | 8 | 55 | 22 | −1.4 |
| Example 4 | | | | | |
| Comparative | 30 | 12 | 63 | 28 | −2.4 |
| Example 5 | | | | | |

In Example 1, the calender treatment and the subsequent thermal treatment were given to the lower layer-coated web, thereby hardening the lower layer while lessening pores in the lower layer. In addition, the subbing layer was provided on the lower layer and cured by irradiation with electron beams, thereby filling in pores present at the surface of the lower layer. Thus, the magnetic substance was prevented from being buried in the lower layer. Consequently, the standard deviation σ_{d} of magnetic substance distribution in the thickness direction at the interface became small to result in achievement of satisfactory output variation rate and high SNR.

In Example 2, the calender treatment and the subsequent electron-beam irradiation treatment were given to the lower layer-coated web, thereby curing the lower layer while lessening pores in the lower layer, and besides, the subbing layer is provided on the lower layer and cured by irradiation with electron beams to fill in pores present at the surface of the lower layer. Thus, the magnetic substance is prevented from being buried in the lower layer. Consequently, the standard deviation σ_{d} of magnetic substance distribution in the thickness direction at the interface became small to result in achievement of satisfactory output variation rate and high SNR.

In Example 3, the subbing layer was provided directly on the support and then subjected to electron-beam irradiation treatment, thereby masking the surface roughness of the support to form a further smoothed surface. Consequently, the standard deviation σ_{d} of magnetic substance distribution in the thickness direction at the interface became small to result in achievement of satisfactory output variation rate and high SNR.

In Example 4, the magnetic layer was provided directly on the smooth support, and thereby the standard deviation σ_{d} of magnetic substance distribution in the thickness direction at the interface became small to result in achievement of satisfactory output variation rate and high SNR.

In Comparative Example 1, as the lower layer didn't undergo calender treatment, the pores present at the surface of the lower layer remained large and the magnetic substance became embedded in the pores. So, the standard deviation σ_{d} of magnetic substance distribution in the thickness direction at the interface became large, and degradation in output variation rate and SNR was caused.

In Comparative Example 2, the lower layer didn't undergo calender treatment, so the pores present at the surface of the lower layer remained large and the magnetic substance became embedded in the pores. As a result, the standard deviation σ_{d} of magnetic substance distribution in the thickness direction at the interface became large. Moreover, the magnetic layer thickness δ exceeded 100 nm. Such being the case, there occurred degradation in output variation rate and SNR.

In Comparative Example 3, as the magnetic layer was coated using the wet-on-wet method, the magnetic substance and the powder in the nonmagnetic lower layer were mixed together at the interface, and thereby the standard deviation σ_{d} of magnetic substance distribution in the thickness direction at the interface became large. This being the case, there occurred degradation in output variation rate and SNR.

In Comparative Example 4, though the lower layer was subjected in advance to calender treatment and thereby the pores at the surface of the lower layer were lessened, no curing treatment was given thereto. As a result, the surface of the lower layer got rough when the magnetic coating composition was applied to the lower layer, and the standard deviation σ_{d} of magnetic substance distribution in the thickness direction at the interface became large. This being the case, there occurred degradation in output variation rate and SNR.

In Comparative Example 5, as the magnetic coating composition was applied to the lower layer in accordance with the wet-on-dry method without giving any treatment to the lower layer, the surface of the lower layer got rough under application of the magnetic coating composition to the lower layer. As a result, the standard deviation σ_{d} of magnetic substance distribution in the thickness direction at the interface became large. Such being the case, there occurred degradation in output variation rate and SNR.

In view of the results mentioned above, the standard deviation σ_{d} of magnetic substance distribution in the thickness direction at the interface, as is determined from depth profiling by TOF-SIMS, has proved to be a characteristic indicating output variations more accurately than the standard deviation σ of magnetic layer thickness determined from TEM observation of ultra-thin slices. This is because, while averaging of the interface between the magnetic layer and the nonmagnetic lower layer is worked out by observation of TEM images of ultra-thin slices, the depth profiling by TOF-SIMS makes it possible to accurately determine the distribution of magnetic powder in the thickness direction at the interface.

More specifically, as in Examples 1 to 4, the average thickness of the magnetic layer is adjusted to the range of 10 to 100 nm and the σ_{d} of magnetic substance distribution in the thickness direction at the interface as determined from depth profiling by TOF-SIMS is controlled to the range of 5 to 50 nm, thereby achieving suppression of output variations and acquisition of excellent electromagnetic conversion characteristics.

According to the invention, the distribution of magnetic powder in the depth direction of the magnetic layer, notably at the interface, can be made uniform, so output variations and electromagnetic conversion characteristics can be significantly improved. In addition, enhancement of areal recording density required from the market is attained, and a high-capacity magnetic recording medium suitable for recording/playback using a GMR head as a playback head can be provided.

The entire disclosure of each and every foreign patent application from which the benefit of foreign priority has been claimed in the present application is incorporated herein by reference, as if fully set forth.

What is claimed is:

1. A magnetic recording medium comprising:
a nonmagnetic support; and
a magnetic layer that comprises:
a binder; and
ferromagnetic powder dispersed in the binder,
wherein δ is 10 to 100 nm; and
σ_{d} is from 5 to 50 nm in terms of coating layer in the magnetic recording medium,
wherein δ represents an average thickness of the magnetic layer; and
σ_{d} represents a standard deviation that is obtained by measuring by TOF-SIMS a depth profile of an element present only in the magnetic layer among elements constituting the ferromagnetic powder and subjecting a differential curve of the depth profile to a normal distribution curve fitting.

2. The magnetic recording medium according to claim 1,
wherein δ is 20 to 90 nm.

3. The magnetic recording medium according to claim 1,
wherein δ is 30 to 80 nm.

4. The magnetic recording medium according to claim 1,
wherein σ_{d} is from 5 to 40 nm in terms of coating layer in the magnetic recording medium.

5. The magnetic recording medium according to claim 1,
wherein σ_{d} is from 5 to 20 nm in terms of coating layer in the magnetic recording medium.
